(19) United States
(12) Patent Application Publication
(10) Pub. No.: US 2009/0037362 A1
(43) Pub. Date: Feb. 5, 2009

(54) METHOD OF AND SOFTWARE FOR PERFORMING A TASK

(76) Inventor: Stephen James Fox, Queensland (AU)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/595,377

(22) PCT Filed: Oct. 15, 2004
(86) PCT No.: PCT/AU04/01426

§ 371 Date: Apr. 13, 2006

(30) Foreign Application Priority Data
Oct. 17, 2003 (AU) 2003905708

(51) Int. Cl. G06F 17/30; G06F 7/00

(52) U.S. Cl. 707/1; 707/102; 707/E17.001; 707/E17.005; 707/E17.01

(57) ABSTRACT

A method of establishing a computerised system and software for performing a task, including creating a list of actions (“action list”) to be done by a practitioner in performing a task for storage on a computer; creating a database of information relevant to the actions on the action list for storage on the computer; providing means for associating the actions in the action list with the relevant information in the database; providing file opening means for opening a file for the task to be performed; providing means for creating a file action list in the file to be opened for the task to be performed corresponding to the action list; and providing data input means for inputting data relevant to the actions to be done on the file action list.

### FIELD OF INVENTION

THIS INVENTION relates to a method of, and software for, performing a task. The invention has particular application to performance of tasks of the type typically carried out by practitioners in law, accounting, engineering, financial planning, real estate, administration and many others, but it not limited to those fields of endeavour.

### BACKGROUND ART

Practice management software is presently available for streamlining the operation of professional practices. Typically such software includes a diary, time usage recording and billing, and file management components. Such software is generally aimed at assisting a practitioner to manage time effectively and ensuring that time spent is properly billed to the file. It does not help the practitioner to actually do the task at hand.

Some software includes document management components adapted to streamline preparation of routine documentation of the type sometimes required in various professional practices. While such software does help a practitioner to the extent that document preparation is easier, its assistance is effectively limited to assistance in a predetermined clerical function and the practitioner must still firstly determine whether documents are required, what documents are required and what information is to be included in the documents. Such software does not assist a practitioner to actually do a task which is required to be done beyond providing forms. For example, such software does not guide the practitioner as to the necessary steps or procedures required to be done to carry out a task. Many practitioners have to resort to the use of precedents in order to carry out a task. However, it is difficult to maintain and operate an effective precedent system which allows a practitioner to find a suitable precedent and be reasonably certain that it has not been superceded, for example, by development of new knowledge, new law, or a change in practice.

One problem that practitioners may face is that a large quantity of textual and/or graphical information is provided which is pertinent to the expertise or profession of the practitioner. Such information may be in the form of books, journals, online resources and such like. It is sometimes very difficult for the practitioner to recall where information relevant to a task is located, or even if the practitioner can remember which text book has the information, the practitioner is reliant on the text book having an effective index.

One object of the present invention is to provide a method of performing a task which alleviates one or more of the shortcomings of the presently known methods of performing a task. Another object is to provide software for carrying out the method. Other objects and advantages of the invention may become apparent from the following description.

### DISCLOSURE OF THE INVENTION

With the foregoing in view, the invention in one aspect resides broadly in a method of establishing a computerised system for performing a task, including:
creating a list of actions (“action list”) to be done by a practitioner in performing a task for storage on a computer;
creating a database of information relevant to the actions on the action list for storage on the computer;
providing means for associating the actions in the action list with the relevant information in the database;
providing file opening means for opening a file for the task to be performed;
providing means for creating a file action list in the file to be opened for the task to be performed corresponding to the action list; and
providing data input means for inputting data relevant to the actions to be done on the file action list.

In another aspect, the present invention resides broadly in a computerised method of performing a task, including:
selecting a list of actions to be done by a practitioner in performing a task from a plurality of lists of actions, each list of actions being associated with information in a database of information relevant to the actions on that list;
opening a file for the task to be performed and creating a file action list in the file corresponding to the selected action list; and
inputting data in the file relevant to the actions to be done on the file action list.

In another aspect the invention resides broadly in a method of establishing a computerised system for performing a plurality of tasks, including;
creating a plurality of lists of actions (“action lists”) for storage on a computer, each action list including actions to be done in performing one or more of the tasks in the plurality of tasks;
creating a database of information relevant to the actions on the action lists for storage on the computer;
providing means for associating the actions in the action lists with the relevant information in the database; and
providing means for associating an action list with a task to be performed.

Preferably, the method also includes the following:
providing file opening means for opening a file for a task to be performed selected from the plurality of tasks;
providing means for creating a file action list in the file to be opened for the task to be performed corresponding to the action list for the selected task; and
providing data input means for inputting data relevant to the actions to be done on the file action list.

In another aspect the invention resides broadly in a computerised method of performing a task, including:
selecting a task to be performed from a plurality of tasks each task being associated with a list of actions to be done in performing that task (“action list”), each list of actions being associated with information in a database of information relevant to the actions on that list;
opening a file for the task to be performed and creating a file action list in the file corresponding to the action list for the selected task; and
inputting data in the file relevant to the actions to be done on the file action list.
Preferably, the method includes providing means for storing the data for retrieval whereby the actions which have been done can be viewed.

In another aspect the invention resides broadly in a method of establishing a computerised system for performing a plurality of tasks, including;
creating a list of tasks to be performed;
creating a plurality of lists of actions (“action lists”) for storage on a computer, each action list including actions to be done by a practitioner in performing a task;
creating a database of information relevant to each action to be done for storage on the computer;
associating each action in the plurality of action lists with information in the database relevant to doing that action; and
providing means for accessing information in the database relating to an action to be taken.

In another aspect the invention resides broadly in a method of establishing a computerised system for performing a plurality of tasks, including;
creating a list of tasks to be performed;
creating a plurality of lists of actions (“action lists”) for storage on a computer, each action list including actions to be done by a practitioner in performing each of the tasks in the list of tasks;
creating a database of information relevant to the actions in the action lists;
associating each action in the plurality of action lists with information in the database relevant to doing that action; and
providing modification means for modifying the lists of tasks, lists of actions and/or the information in the database.

In another aspect, this invention resides broadly in a computer-based method of performing a task including:

displaying a checklist of actions to be done by the user to complete the task;

selecting one or more of the actions to be done to complete at least in part the task;

identifying one or more operations to be executed by reference to the action or to one or more other criteria;

entering data relevant to at least some actions and/or operations relevant to the doing or execution thereof; and

storing the data so entered whereby the user can check the extent to which actions and/or operations have been completed or executed in performing the task.

Preferably, the method includes providing means for arranging the file according to a predetermined order. In one form, the method includes providing means for arranging the file according to actions taken or to be taken and in another form the actions can be arranged in date order. However, in a more preferred form the method provides means for arranging the file in any suitable order at the option of the practitioner. The checklist may present the user with, for example, one or more queries. Queries may require simple answers, such as “yes” or “no”, or more details answers, such as a name, address or such like.

In another aspect the invention resides broadly in a computer-based system operable for performing a task, including:
display means for displaying actions to be done or considered by a practitioner in performing a task to be performed;
database accessing means operably associated with the displayed actions for accessing information in a database relevant to the actions displayed;
data input means operably associated with the displayed actions for entering data obtained by reference to the information in the database;
data storage means for storing data entered via the data input means; and
data retrieval means for retrieval of the data entered whereby actions which have been done and/or considered can be viewed.

Preferably, the system includes means to display the data for viewing by a user. Preferably, a front-end interface is provided operable for interactive input by a user, the front-end interface providing a plurality of menu or command based entry points to a selection of practice modules each of which relates to a task. Preferably, the front-end interface provides for user identity input so that a plurality of users may use the system and/or method, and a plurality of action lists is provided for the user to select a task to be performed from a plurality of different tasks.

Within each action, the data input means preferably includes selection means for selecting a range of different operations, depending on the nature of the action to be completed. For example, the selection means may provide for selection of alternative choice modules, help modules, precedent modules, documentation modules and such like. Additionally, the operations could include date entry, check box entry, radio buttons, comment fields et cetera.

Preferably, the front-end interface includes a log-in module operable to provide individual users with a log-in identity, suitably including a log-in password. It is also preferred that the front-end interface operatively interacts with a practice management engine operable to call the front-end interface and professional practice modules.

In another aspect, the present invention resides broadly in a computer-based system for performing a task including:
a list of actions (“action list”) to be done by a user to perform a task to be performed, the action list being displayable on a computer screen;
data input means operatively associated with each action in the action list for input of data relevant to the action;
data storage means for storing data entered via the data input means for display with the action list whereby a user may check which actions have been done in performing the task.

In another aspect, the present invention resides broadly in a computer program for assisting a practitioner in performing a task, including:
means for displaying actions to be done or considered by a practitioner in performing a task to be performed;
means for accessing information in a database relevant to the actions displayed;
means for entering data obtained by reference to the information in the database;
means for storing data entered via the data input means; and
means for retrieval of the data entered whereby actions which have been done and/or considered can be viewed.

In another aspect, the present invention resides broadly in software for performing a plurality of tasks, including:
a database adapted to contain information relevant to actions to be done or considered in performing a plurality of tasks;
a file opening module operable to open a file for a task to be performed selected from the plurality of tasks;
a display module operable to display information from the database relevant to actions to be considered or done in performing the selected task;
a data input module operable to provide for the input of data relevant to the actions to be considered or done in performing the selected task; and
a data storage module for storing data in the file.

Preferably, the data in the file is stored in the database of information.

Preferably, the software includes a front-end interface operable by a user and having a plurality of selectable call functions embedded therein. It is also preferred that the call functions are operable to call any one of a plurality of professional practice modules each relating to a task to be performed selected from the plurality of tasks.

Preferably, the front-end interface includes log-in software operable to provide individual users with a log-in identity, suitably including a log-in password. Preferably, the front-end interface operatively interacts with a practice management engine operable to call the front-end interface and professional practice modules.

In another aspect, the present invention resides broadly in a method of performing a plurality of tasks including:

running a program on one or more computers so as to integrate software processes, the processes including:
a database process operable to store and retrieve information relevant to actions to be done or considered in performing a plurality of tasks;
a file opening process operable to open a file for a task to be performed selected from the plurality of tasks;
a display process operable to display information from the database relevant to actions to be considered or done in performing the selected task;
a data input process operable to provide for the input of data relevant to the actions to be considered or done in performing the selected task; and
a data storage process for storing data in the file.

Preferably, the data storage process integrates the data in the file into the database of information. Preferably, the processes further include a front-end interface operable for interactive input by a user, the front-end interface providing a plurality of menu or command based entry points. It is further preferred that the processes include a plurality of practitioner processes selectable from said entry points, each practice process relating to an action to be done in completing the task.

In another aspect the invention resides broadly in a method of modifying a master list of actions to be done by a practitioner in performing a task, the master list being accessible by one or more users in a network of computers, including:
providing a database of information relevant to the actions on the master list stored on one or more of the computers in the network, the information being relevant information in the database;
opening a file for the task to be performed and establishing a file action list corresponding to the master list in the file;
adding a modification to the file action list to create a modified action list; and

saving the modification to the master action list.

Preferably, the method includes selecting a choice from a group containing the options of whether to make the modification to the file action list and the master action list or only the file action list.

In another aspect the invention resides broadly in a computer based system for performing a task, including:
a database of information including a master list of actions to be done or considered by a practitioner in performing a task to be performed;
file opening means for opening a file for the task to be performed and establishing a file action list corresponding to the master list in the file;
data input means for inputting data for adding a modification to the file action list to create a modified action list; and
data storage means for storing the modification in the master action list.

Preferably, the system includes selection means for selecting whether to store the modification in the master action list or only the file action list.

In another aspect, the present invention resides broadly in a computerised method of performing a task including:
having an expert in a field prepare a list of actions (“action list”) to be done in performing a task in that field;
having the expert provide relevant information associated with the actions on that list;
entering the list of actions and the information into a database; and
providing software operable to associate the information in the database with the actions to be done in performing the task.

In another aspect the invention resides broadly in a method of arranging information on a computer system relating to tasks to be performed by a practitioner, the method including:
providing a database including information required for performing a plurality of tasks;
creating an action list of actions to be done in performing each of the tasks to be performed;
operatively associating the information in the database with the actions to be done in performing each of the plurality of tasks.

The activity or activities to be done in each action include document related and non-document related activities. The document related activities preferably use a digital form having a selection of form fields for inputting data for storage and display. The non-document related activities may require, for example, that the user make a telephone enquiry, review that particular activities have been completed, check on the status, existence, disposition or the like of something relevant to the performance or completion of the task. In such form, a form is provided on the computer screen in similar fashion to the form provided for the document related activities, thus permitting the documentation of non-document related activities. Document related activities may include, for example, sending a letter or generating a contract. The form may provide a link to precedents and/or standard document formats.

It is also preferred that the method, software and system of the present invention provide for the setting up of new action lists for new tasks. It is further preferred that capability for editing, updating and/or modification of existing action lists be provided. Preferably, the method, software and system of the present invention includes provision for tasks to be individualised and/or categorised. Preferably, the characterisation is customer based, and the individualisation is matter based, whereby a plurality of tasks may be performed for a customer of the user, and individual tasks may be equated with a matter. For example, if the user is a solicitor acting for a customer in respect of a property transaction, the customer is established as an entity in the software or system by entry of details relevant to the customer, and a matter may be opened for that customer as task having an action list of activities to be done in completing the conveyance on behalf of the customer. When a new matter is opened for a client and during the doing of the actions listed in the action list, it is determined that the actions or activities require editing, the user is provided with an option to enter an editing module to make the changes. Prior to exiting the editing module, the user is preferably given a choice as to whether to make the changes “client specific” for particular users, or “server specific” for all users.

The method, software and system of the present invention is preferably operable over a network of computers using distributed processing amongst one or more server computers and one or more client computers operatively attached in a configuration suitable for the particular network about which the invention is installed. The network may be a local area network, wide area network, but is preferably an Internet-based network. It is also preferred that the software be operatively associated with normal server side services to accommodate the execution of the method of the invention as a relational database having data tables relevant to customer information, user information, matter information and information relating to the action lists. The practice management engine operatively associates the relevant records from each data table in order to function within software processes selected from the front-end interface.

Preferably, the tasks are categorised into a range of kinds dependent on their intended usage. Preferably, the kinds include client-based action lists usable on client computers, article-based action lists which act more or less like help files providing text- or hypertext-based instructions for carrying out a task, and master action lists to which additional actions may be added by classes of users, such as all users in a particular firm, action-list moderators and such like. Access to knowledge in help files, precedents, pro-form a documents and the like can be flagged for individual users or classes of users, and provision made for the addition of additional material. Moreover, the method, software and system of the present invention preferable further provides for users to make suggestions for changes to be made to the master.

It is also preferred that the method, software and system of the present invention provide for the recording of activity on each file to provide an audit trail. In order to make such provision, it is preferred that a record be maintained of when actions in the relevant action list stored in relation to that file were accessed. It is also preferred that the user be allocated a review user or supervisor. It is also preferred that the method, software and system of the present invention provide for messages, such as email messages, “to do” lists or the like be generated for actions not completed in the task until the appropriate information has been entered to indicate that the activity for that action has been done. It is preferred that task-status messages or reports be accessible from the front-end interface. In a further preferred form, messages are automatically generated according to a predetermined timetable for each file which has been opened, preferably by sending an email message to the user.

It is also preferred that actions described in relation to the method, software and system of the present invention include selection means for selecting one option from a plurality of options wherein the selection of at least one of the options generates additional actions to be completed, whereas one or more other selections permits the user to proceed to the next action in the action list. In another form, the selection of particular options in an action list may provide branching of the action list to sub-lists of actions. However, it is preferred that action lists do not branch as such, but rather separate action lists be provided with sufficient detail in the selection process to enable the appropriate action list to be selected from the front-end interface. For example, although in a property purchase there may be actions which would be common to the purchase of a commercial property and a residential property, it is preferred that separate action lists are provided for selection by the user.

The system allows the user to expand on the action list in a matter and that expansion automatically goes through to the master action list. If the user is working on a matter and finds that some additional action is required for that particular matter, then the user can automatically add that to the master action list, or alternatively just add it to that particular matter. If the additional item or task is added to the master action list, it will come up for all subsequent matters in which that task is to be completed. Thus, the user has a direct connection between a task and the action list and any documents and information relating to carrying out the task. For example, the task might be in relation to building inspection; while the user is in that item of the action list, the user can then link to documents, whereupon a list of precedent documents dealing with that issue is displayed for selection. Thus, there is a close association between the task and the documents required to carry out the tasks with the action list as the user moves through the action list. Also, by selecting the document icon, the user can bring up precedents in the master for that particular item in the action list and can also bring up documents which relate to that item in the particular matter.

The user can also bring up a list of all documents on the matter and from the list go to any particular document as required or desired. Accordingly, the method system and software of the present invention includes a document management aspect. The system also permits linking to a diary and provides an audit trail for the carrying out of tasks. In relation to the audit trail, on each phase at any time during the phase, the user can produce a status report on the tasks within that phase to the client or to the firm by selecting the appropriate icon. Preferably, the report is provided in an email which has the information collated into the body of the email and the address and other information is wrapped around the message and sent.

In another aspect, the present invention resides broadly in a method of establishing a computerised system for performing a task, including:
creating a list of actions (“action list”) to be done by a practitioner in performing a task for storage on a computer;
creating an action database including information relevant to the actions on the action list for storage on the computer;
creating a subscribers database including information relevant to subscribers having access to the computerised system;
creating an information database including information (“professional information”) relevant to a field of practice of the practitioner;
creating a publisher database including information relevant to publishers of professional information;
providing means for associating the actions in the action list with the relevant information in the database;
providing file opening means for opening a file for the task to be performed;
providing means for creating a file action list in the file to be opened for the task to be performed corresponding to the action list;
providing database access means for subscribers to subscribe to information contained in any one or more of the databases; and
providing data input means for inputting data relevant to the actions to be done on the file action list.

In one form, the publishers information and subscribers information are integrated into a single database. In such form, a publishers checklist may be mixed with a subscribers checklist in order to provide a single checklist for a given matter. In other words, although information relevant to a matter may be sourced from several sources, a single checklist is preferably generated for that matter, including, for example, professional information as well as the action list.

### BRIEF DESCRIPTION OF THE DRAWINGS

In order that the invention may be more readily understood and put into practical effect, reference will now be made to the accompanying drawings which collectively illustrate some of the computer screen displays resulting from the operation of a preferred embodiment of the invention. That embodiment illustrates use of the invention by a lawyer in performing a task which in this case is a contract for lease of premises and the drawings in brief are as follows:

FIG. 1 is a diagrammatic representation of a log-in screen according to the invention;

FIG. 2 is a diagrammatic representation of a selection screen which is presented to a user upon satisfactory input into the log-in screen of FIG. 1;

FIG. 3 is a diagrammatic representation of a client selection screen which is presented to a user upon linking from one of the links in the selection screen of FIG. 2;

FIG. 4 is a diagrammatic representation of the client selection screen of FIG. 3 with a client selection window overlaid thereon;

FIG. 5 is a diagrammatic representation of the selection screen of FIG. 3 with client data input and a calendar window overlaid thereon;

FIG. 6 is a diagrammatic representation of the client selection screen of FIG. 3 with the client data and date opened data entered therein;

FIG. 7 is a diagrammatic representation of a matter selection screen for selection of matters from a plurality of clients;

FIG. 8 is a diagrammatic representation of a matter selection screen for selection of a matter for a particular client;

FIG. 9 is a diagrammatic representation of a document selection screen for selecting documents pertaining to matters;

FIG. 10 is a diagrammatic representation of an author input screen;

FIG. 11 is a diagrammatic representation of the author selection screen of FIG. 10 with one of the available authors selected;

FIG. 12 is a diagrammatic representation of a checklist selection screen according to the invention;

FIG. 13 is a diagrammatic representation of a checklist screen for a purchase of a real property;

FIGS. 14, 15 and 16 are diagrammatic representations of further detail task selection screens which are presented to a user upon linking from one of the tasks in the checklist screen of FIG. 13;

FIG. 17 is a diagrammatic representation of a document template linking screen according to the invention;

FIG. 18 is a diagrammatic representation of a checklist screen with a document linking window superimposed thereon;

FIG. 19 is a diagrammatic representation of a checklist screen showing the presentation of sub-tasks upon appropriate entry of a drop-down box superimposed thereon;

FIG. 20 is a diagrammatic representation of a checklist screen in further detail presented to a user upon entry of one of the links in the checklist screen of FIG. 13;

FIG. 21 is a diagrammatic representation of a checklist screen of FIG. 20 with a window superimposed thereon for selection of examples, precedents, notes or matter documents;

FIG. 22 is a diagrammatic representation of an author detail screen similar to that of FIG. 10 awaiting input of selection of a supervisor;

FIG. 23 is a diagrammatic representation of the author selection screen of FIG. 22 with an author selected an a supervisor selected;

FIG. 24 is a diagrammatic representation of a blank version of the checklist selection screen similar to that of FIG. 12;

FIG. 25 is a diagrammatic representation of the checklist selection screen of FIG. 24 with a template selected for a particular matter;

FIG. 26 is a diagrammatic representation of a checklist screen showing a balloon text box overlaid thereon upon hovering a mouse pointer over an icon;

FIG. 27 is a diagrammatic representation of an action generation screen according to the invention;

FIG. 28 is a diagrammatic representation of an expanded checklist screen according to the invention;

FIG. 29 is a diagrammatic representation of a checklist screen showing further tasks for the checklist of FIG. 13;

FIG. 30 is a diagrammatic representation of a report selection screen according to the invention;

FIGS. 31 and 32 are diagrammatic representations of the report selection screen of FIG. 30 with a matter report window and a due date report window overlaid thereon respectively;

FIG. 33 is a diagrammatic representation of an administration section welcome screen according to the invention;

FIG. 34 is a diagrammatic representation of a company detail screen according to the invention;

FIG. 35 is a diagrammatic representation of a user selection screen according to the invention;

FIG. 36 is a diagrammatic representation of a user data entry screen presented to a user upon linking from the user selection screen of FIG. 35;

FIG. 37 is a diagrammatic representation of a checklist properties screen for editing or adding properties to a checklist according to the invention;

FIG. 38 is a diagrammatic representation of a checklist properties of FIG. 37 with additional information provided thereon upon linking from the checklist properties screen of FIG. 37;

FIG. 39 is a new document screen presented to a user having a document loading window overlaid thereon;

FIG. 40 is a diagrammatic representation of a screen showing integration of the software processes of the present invention with a messaging, calendar, contact and task management application;

FIG. 41 is a block diagram showing the structural relationship between subscribers, publishers and a checklist administrator according to the invention;

FIG. 42 is a diagrammatic representation of a screen showing a sample checklist of publishers and subscribers which may be accommodated by the structural relationship set out in FIG. 41;

FIG. 43 is a diagrammatic representation of a screen showing a sample of subscriber details which may be accommodated by the structural relationship set out in FIG. 41;

FIG. 44 is a diagrammatic representation of a screen showing a checklist for a checklist administrator which may be accommodated by the structural relationship set out in FIG. 41;

FIG. 45 is a diagrammatic representation of a screen showing a checklist for the subscriber of FIG. 43;

FIG. 46 is a diagrammatic representation of a screen showing a checklist of actions for one of the tasks which may be performed from the checklist of FIG. 45; and

FIG. 47 is a diagrammatic representation of a screen showing sample merge fields for use in doing the actions in the checklist of FIG. 46.

### DETAILED DESCRIPTION OF THE DRAWINGS

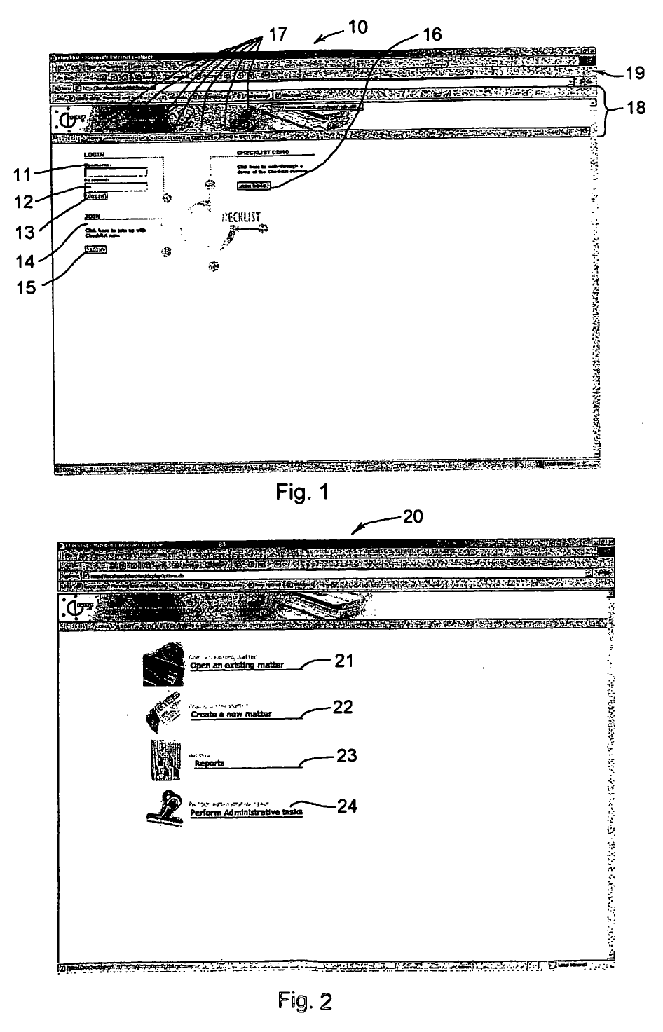

The login screen 10 shown in FIG. 1 includes a user name text box 11 under the caption “Username:” and into which a user's name may be entered, and a password text box 12 under the caption “Password:”, aligned under the user name text box and into which a password may be entered. After the user name and password have been entered, a submit button 13, having the text “LOGIN” thereon and aligned below the text boxes may be pressed in known manner. The login screen is of known-type commonly available in software systems to enable a user to access a computer and/or the software installed thereon, but also includes a name input text box 14 under the caption “JOIN” and the following features. A run demo button 16 is provided to the right of the username and password text boxes. A page header 18 is provided along the top of the screen below the browser header 19. Seven link tabs 17 are along the lower edge of the page header to provide for a user to hyperlink to other web pages under the link titles “HOME”, “ABOUT”, “% JOIN”, “SUGGESTIONS”, “CONTACT”, “DEMO” and “OPTIONS”.

Upon entry of correct user name and password data to the system, a selection screen 20 as shown in FIG. 2 is presented to the user on the computer screen. The selection screen includes four hyperlinks, being an “existing file” hyperlink 21, a “new file” hyperlink 22, a “reports” hyperlink 23 and an “administrative tasks” hyperlink 24.

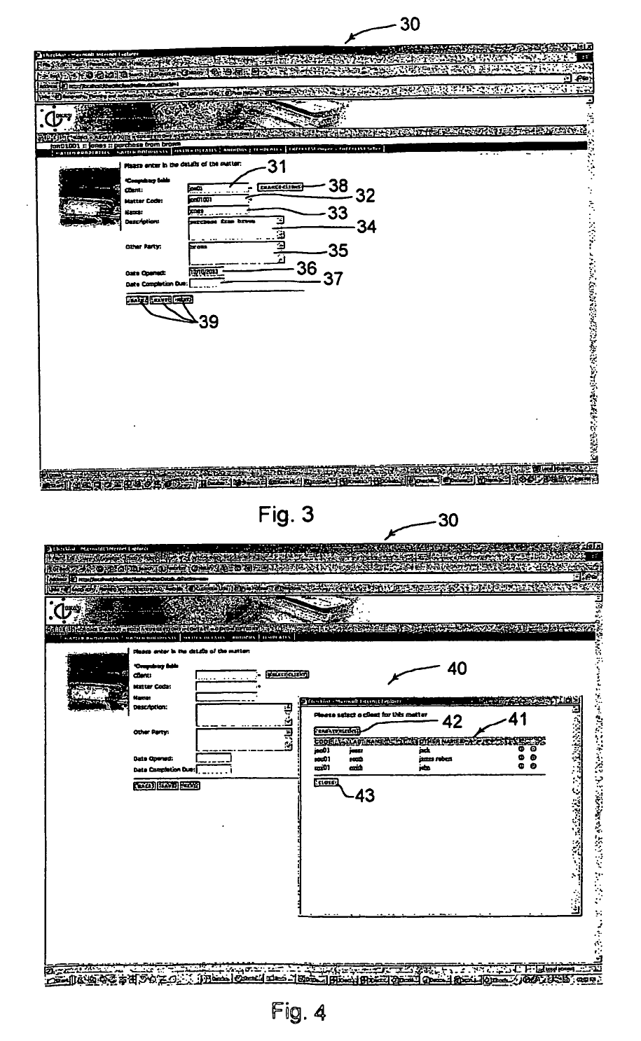

The client data entry screen 30 shown in FIG. 3 includes a client short name text box 31 and aligned thereunder a matter code text box 32, a client name text box 33, a matter description text area 34, and an other party text area 35, a date opened text box 36 and a date completion due text box 37. Additionally, a select client button 38 is provided to the right of the client short name text box and navigation and save buttons 39 are provided below the date completion due text box. Linking from the select client button, a client selection window 40 is overlaid on the client details entry screen as shown in FIG. 4. (The other reference numerals on FIG. 3 had been omitted from FIG. 4.) In the client selection window, the user is provided with a list of clients 41 having the codes, last name and other names of various clients beneath a create clients button 42. Each one of the clients listed provides a link or the like to enter the relevant material into the text areas and text boxes of the client details entry screen to avoid the user having to re-enter data. The client selection window may be closed by pressing the close window button 43 provided just below the client list. Once the client data has been entered, a calendar window 50 is overlaid on the client detail entry screen to permit, by navigation through navigation button 51, month and year drop-down boxes 52 and date selection cells shown typically at 53, an appropriate date may be entered into the date text boxes 36 and 37. The calendar window may be closed by executing the close calendar link 54. Thus, a date may be entered as shown in the partly filled in sample of the client details entry screen 60 as shown in FIG. 6.

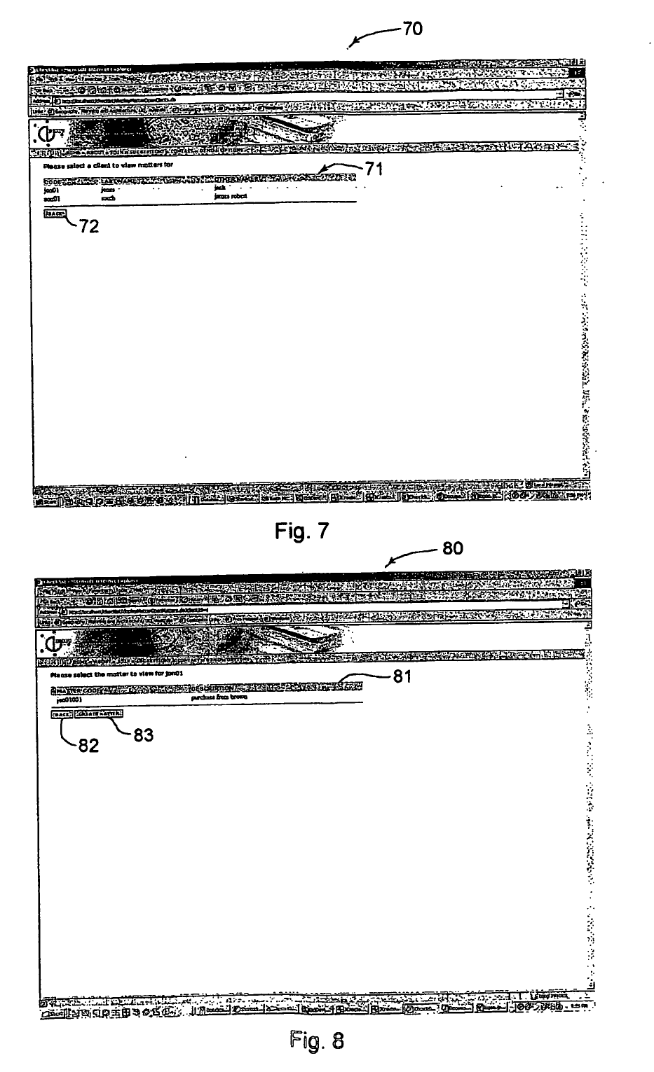

If, instead of creating a new matter, the user wishes to view an existing matter from the link 21 in FIG. 2, the matter selection screen 70 shown in FIG. 7 is presented to the user. A client list 71 is provided in a similar form to the client list displayed in the client selection window 40 of FIG. 4, but this time on the main window of the screen. The same information relating to the client code, last name and other names of the client are revealed, and the screen may be closed upon pressing the navigation “back” button 72 upon selection of a client, a matter list 81 is presented on a matter selection 80 shown in FIG. 8 in the matter list, it can be seen that a matter code and description is provided for each matter for a particular client, the client being indicated by the matter code or client code. A navigation button 82 is provided as well as a create matter button 83 therebeside, both buttons being aligned below the matter list.

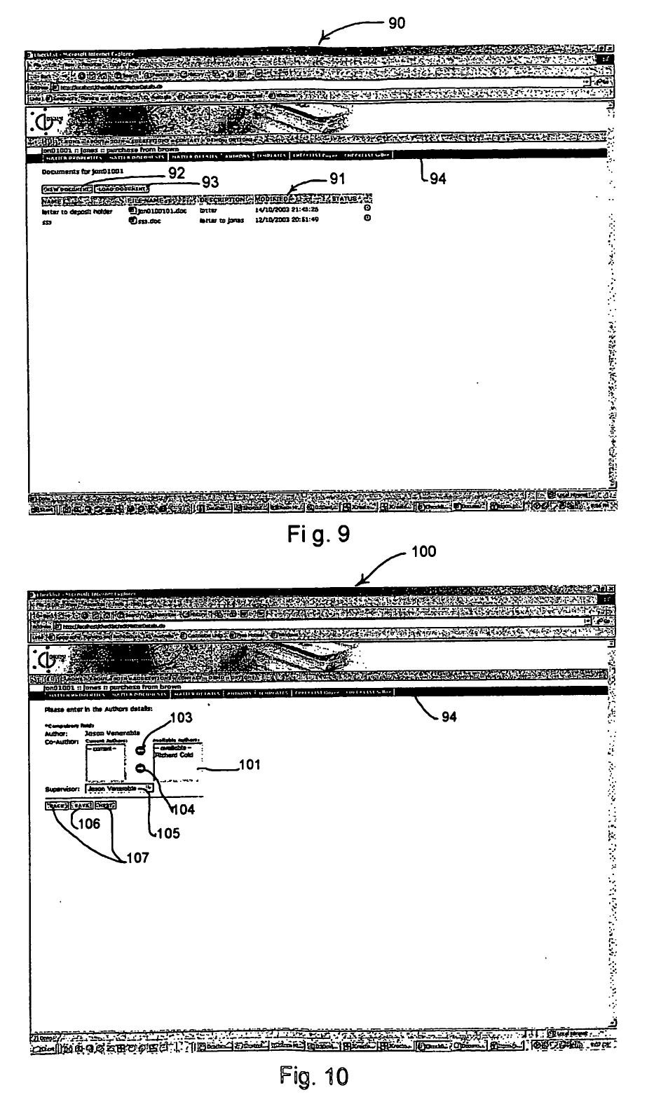

The document selection screen 90 shown in FIG. 9 is a document list 90 provided on the screen with data under the headings “name”, “file name”, “description”, “modified” and “status”. Under the name heading, the name of the document is listed which is a descriptive name of the document in generic terms so that similar documents will have similar names in corresponding matters. Under the file name heading, the name of the actual document filed stored in the computer's directory system is listed. Under the description heading, a descriptive term is given for each document. Under the modified heading, the date and time of modification of the document is listed and under status, the status of the document is given.

Aligned with the left hand edge of the document list and side-by-side are provided a new document button 92 and a load document 93. Executing the new document button will direct the user to a specific screen for creating a new document whereas execution of the load button will direct the user to load a document selected for loading. Above the buttons just described is a title for the page indicating which documents are being shown on the screen, in this case for matter No. jon01001.

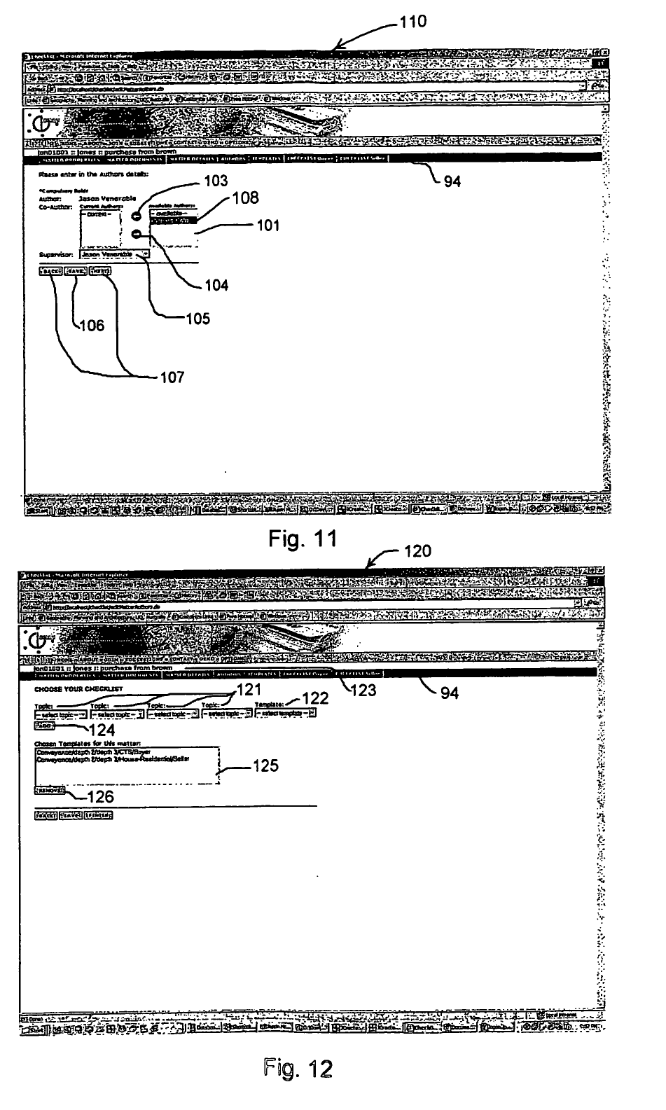

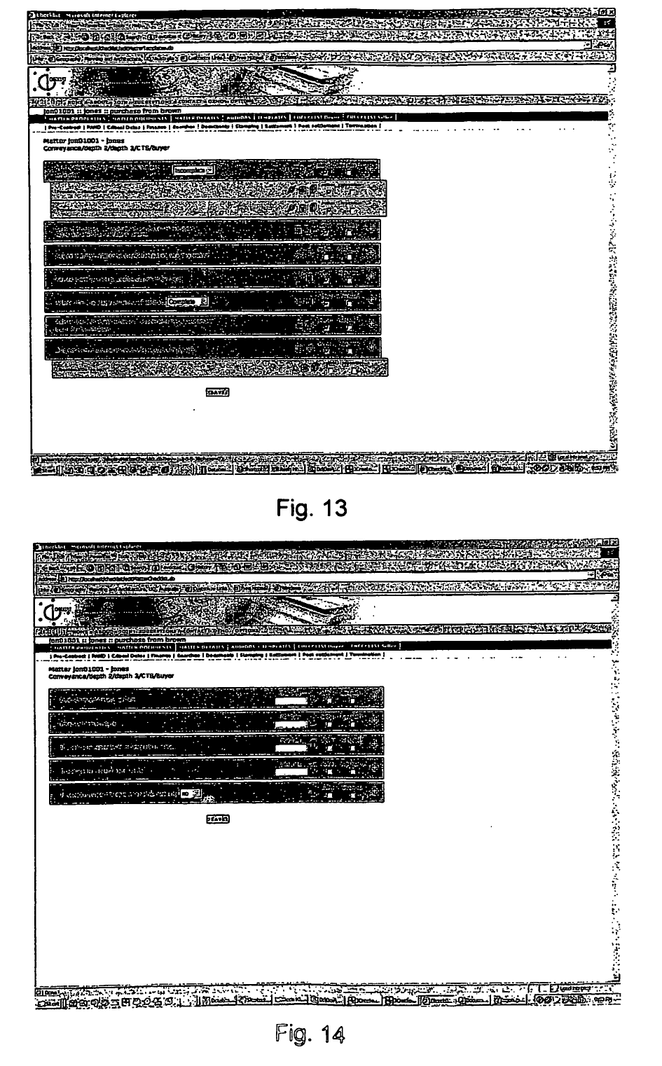

Across the screen and above the page title is a matter jump bar 94 allowing the user to link to matter properties, matter documents, matter details, authors, templates, checklist “buyer” and checklist “seller” as required. When the user executes the authors link from the matter jump bar, they are directed to an author input screen 100 as shown in FIG. 10. Author details can be entered by typing a name into the available authors text area 101 and executing an add author button 103 whereupon the selected author's name will be added to the current author text box 102. Current author can be selected and removed by execution of the remove author button 104. A supervisor for the matter is selected from a list presented in the supervisor downlist 105. Below and aligned with the left of the above described elements are provided back and next location navigation buttons 107 and a save button 106 then the author is selected, the name is highlighted as shown in the selected author field 108 in the author selection screen 110 shown in FIG. 11. The checklist selection screen 120 shown in FIG. 12 has four topic drop-down boxes 121 aligned below the matter jump bar and to the right thereof and aligned therewith a template drop-down box 122. Topics may be selected from the list in each drop-down box. The actual matter is listed in a title bar 123 just above the matter jump bar. An add button 124 is provided to add a topic or a template to a chosen template text area in which templates chosen for the particular matter are listed. Any one of the templates listed in the chosen template text area can be removed by execution of the remove button 126. Selection of one of the templates from the chosen template text area will direct a user to a checklist screen 130 as shown in FIG. 13. Below the title bar and matter jump bar, there is also provided a checklist jump bar 131 and ten different actions shown in typically at 132. Different phases of the checklist are shown in the checklist jump bar to allow the user to move about the task more efficiently, and particularly because the actions listed would usually not fit on one screen. Each action has an action description shown typically at 133 generally to the left of the elongate rectangular box in which a number of other features are normally provided depending upon the kind of activity necessary for completing each action. Accordingly, in the first and seventh actions listed, there is an action drop-down box shown typically at 134, and some of the actions listed have an action notes icon shown typically at 135, an action precedents icon shown typically at 136, and an action links icon shown typically at 137. Each action also has towards the right hand end of its box an author check box shown typically at 111, a supervisor check box shown typically at 112, and an action details link shown typically at 138. Below the bottom of the list is a save button 139 to allow a user to save any data entered into any of the actions listed.

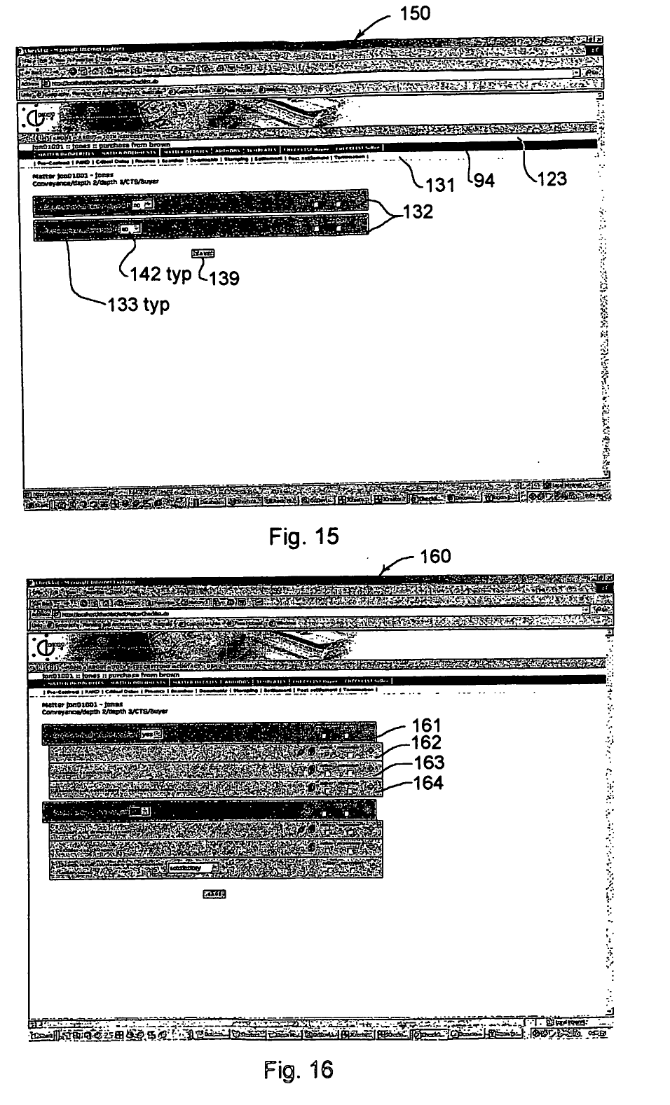

Because all of the actions would not necessarily fit on one screen, further actions can be listed in a further screen as shown in the tasks selection screen 140 in FIG. 14. It can be seen in FIG. 13 in particular that some of the tasks are indented and have a paler background than the other tasks to indicate that they form part of the actions necessary in completing the action above. Generally, these indented actions are expandable and collapsable upon the appropriate entry in the action above. Accordingly, the sixth action listed in the checklist screen 130 is to require the user to, subject to instructions from the client, conduct a title search of the property. As a sub-action thereunder, a review of the title search is required. Of course, if the instruction to conduct the title search is not given, then this action may be completed and the sub-action thereunder collapsed. In the actions listed in FIG. 14, the first four actions listed include a date text box 141 and the fourth one has a true/false downlist 142. The actions description, action drop-down box, true/false downlist, date text box, and the various icons are preferably provided in consistent alignment even when some of the elements are not provided for an action so that the user is provided with a consistent look and feel. Advantageously, the user would then be readily able to determine what activities are necessary to complete an action. The true/false downlist is preferably provide just to the right of the action description as shown in the checklist screen 50 in FIG. 15. For example in the checklist screen 160 shown in FIG. 16, under the action description “is a main roads search required” query is provided a true/false downlist 161. If the “yes” selection is made, then the further actions indented thereunder and having a lighter background are expanded out from that action, the further actions being a request search at 162, to consider the search result at 163 and to search result being satisfactory or appropriate action taken at 164. A similar expanded list is provided under the vendor corporation action at 165. It can be seen by comparing the checklist screens 150 and 160 shown in FIGS. 15 and 16 at where the true/false downlist has the “no” option selected, then the actions are collapsed, as shown in FIG. 15, but where the true/false downlists have the option “yes” selected, then the actions become expanded. Advantageously, the user is then able to efficiently perform a task by not only posing the question as to whether an action needs to be done or not, but in the case where an action is required to be done, by optionally providing a list of actions to be performed when the question is answered in the affirmative, but not cluttering up the users work space with actions that are not required to be done if the question is answered in the negative.

The document template linking screen 170 shown in FIG. 17 has a uniform resource locator text box 171 for entry of a uniform resource locator (URL) belonging to a party whose name is entered in the URL name text box 172. The purpose of this screen is to obtain documents as precedents or templates. If the template is to be modified, then the template modify radio button for “yes” is selected (in the alternative to the “no” radio button) an add property button 175 is also provided to allow a user to add a property to the link or template. The save button may be pressed for saving the link to the document template if required.

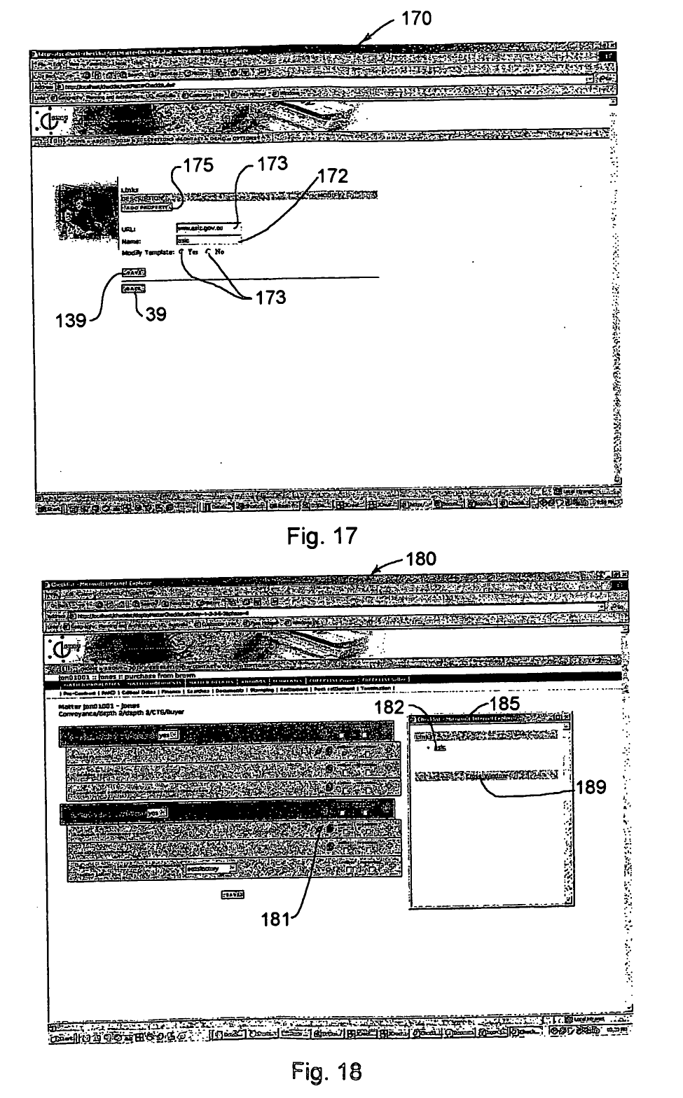

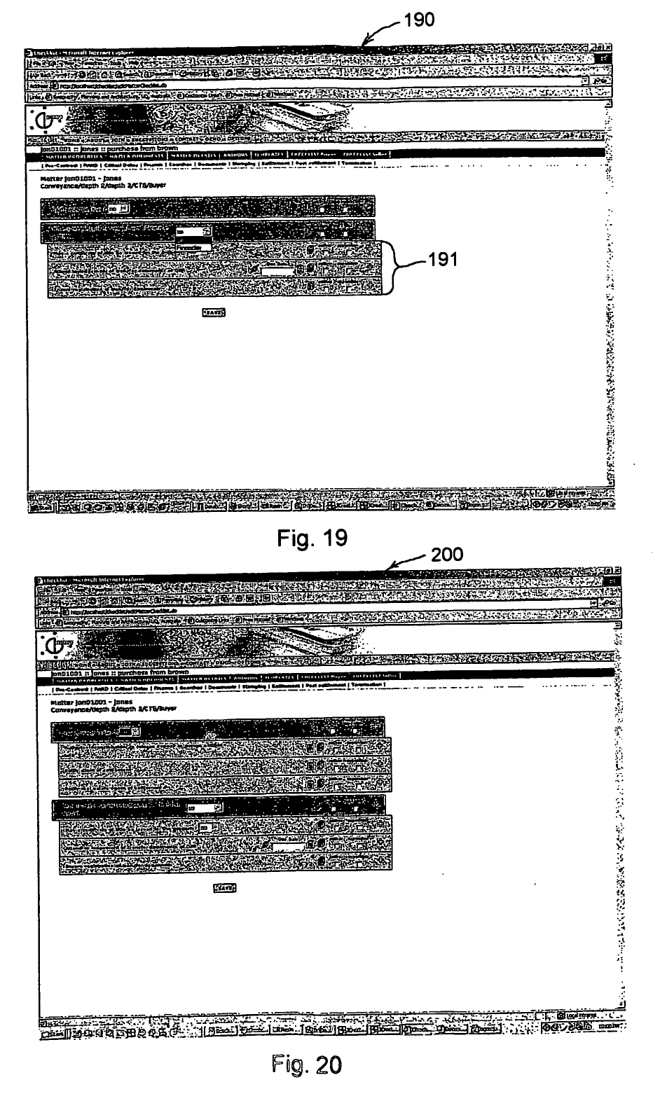

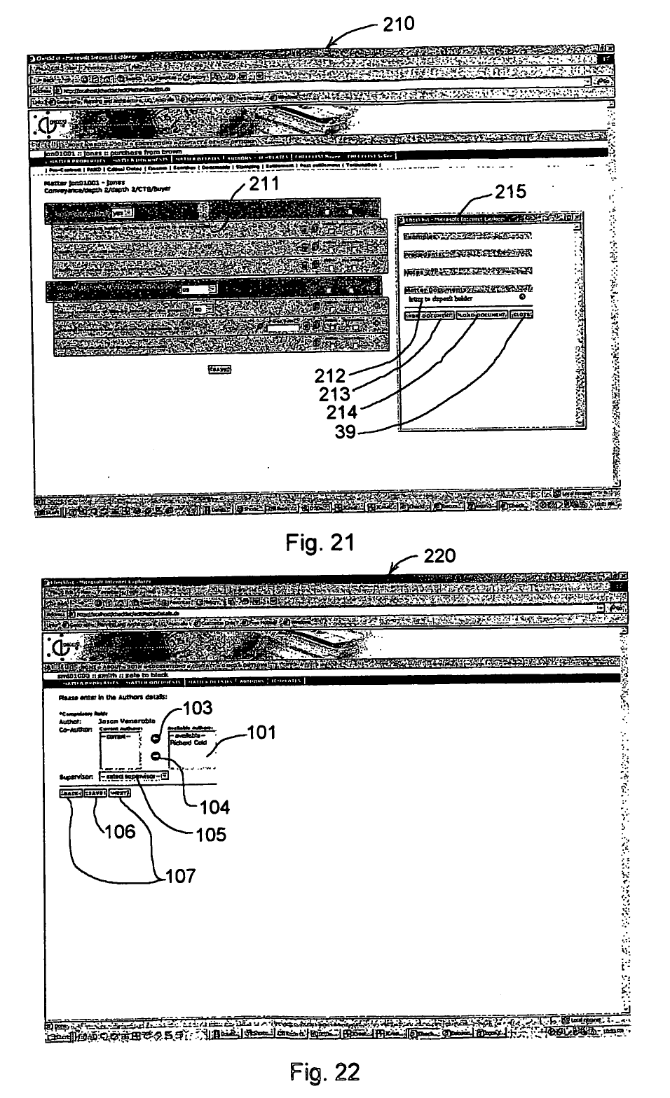

The checklist screens 180, 190, 200 and 210 shown in FIGS. 18, 19, 20 and 21 show further features of the checklist actions accordingly to the invention. If the uniform resource locator 171 from FIG. 17 is selected to be added or saved to the matter, then by executing the company search link 181 shown in FIG. 18, a link window 185 is superimposed on the screen having the URL name presented as a hyperlink at 182 the same as that in the URL name box 172 of FIG. 17. A close window link 189 is also provided to close the company search link window when it is no longer need. However, linking to the URL name will provide the user with an activity to be completed such as actually doing the company search on the ASIC website to enable the user then to go ahead with the next action of considering the search report. In the checklist screen 190 of FIG. 19, the true/false downlist has the alternative selections for who is responsible for lodgement of the transfer, giving the options as “us” or “financier”. The further sub-actions generally listed at 191 are presented if “us” is selected and because the user would be required to perform further actions which would not be required if the “financier” was to be responsible for lodgement of the transfer, in which case the sub-actions 191 would be collapsed and not appear on the screen for the user. In the checklist screen 200 of FIG. 20, the question, “has contract settled” has been answered in the affirmative which has expanded the action out as shown in FIG. 20 from that shown in FIG. 19 in the checklist screen 210 shown in FIG. 21, an action window 215 is overlaid on the screen when the appropriate link in the action “authorise deposit holder to release deposit to person entitled to it” is executed to present the user with an option to produce a letter to deposit holder at the link 212 under the sub-heading “matter documents” listed in the window. Also in the window are provided a new document button 213, a load document 214 and a close button 39. Executing the new document button allows a new document to be entered into the matter, whereas executing the load document button allows a document selected from a list to be entered into the matter.

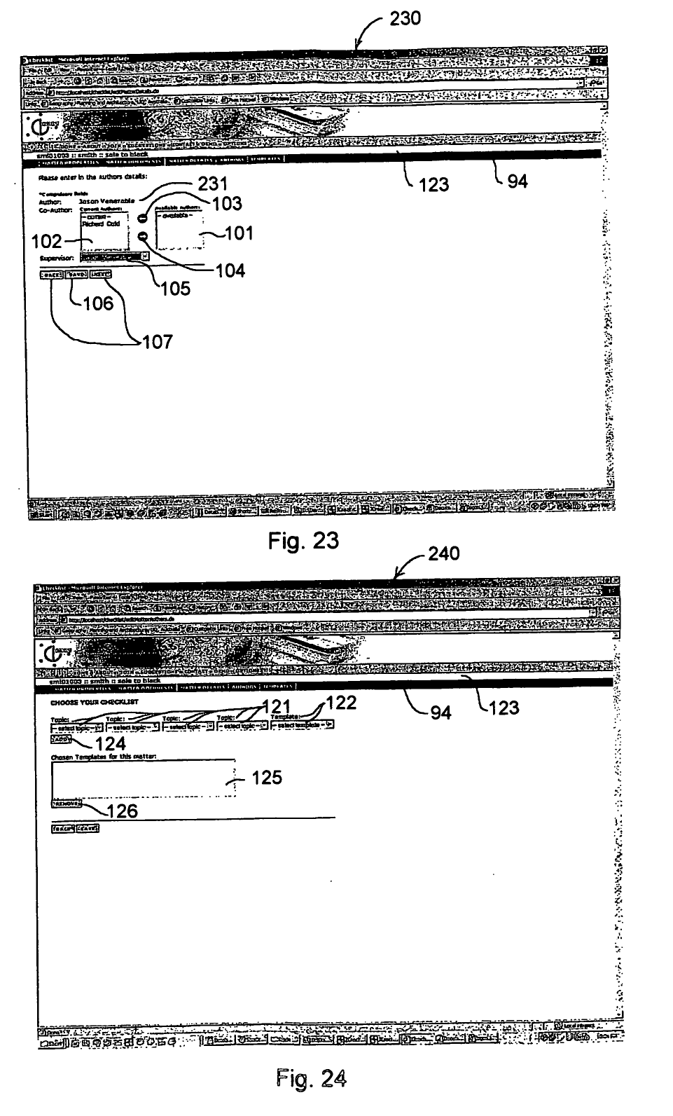

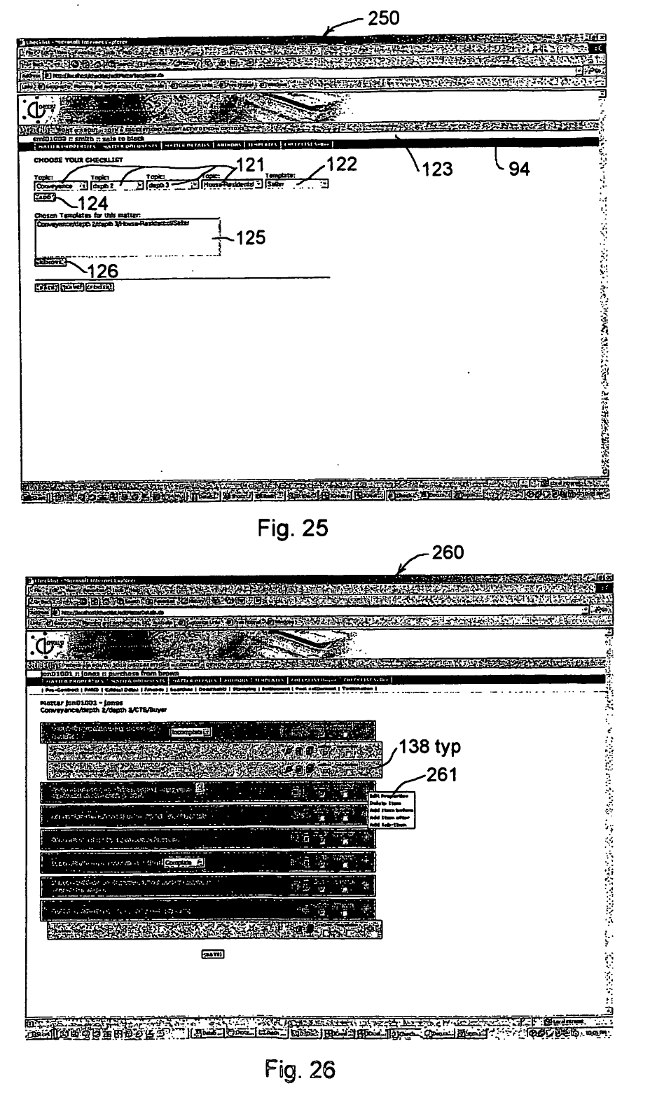

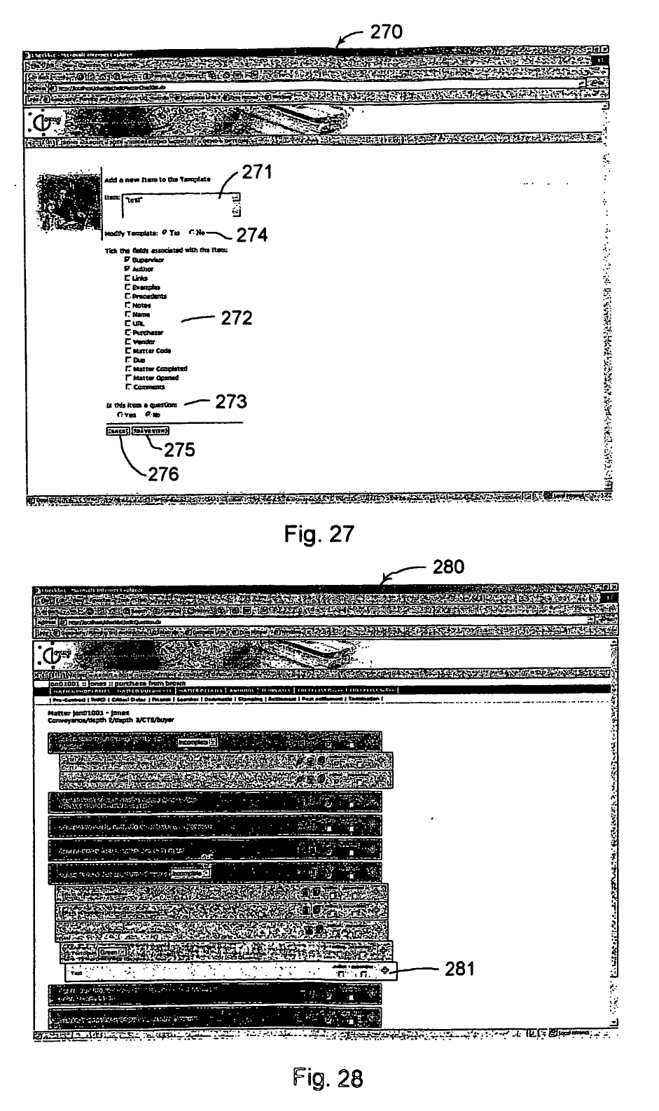

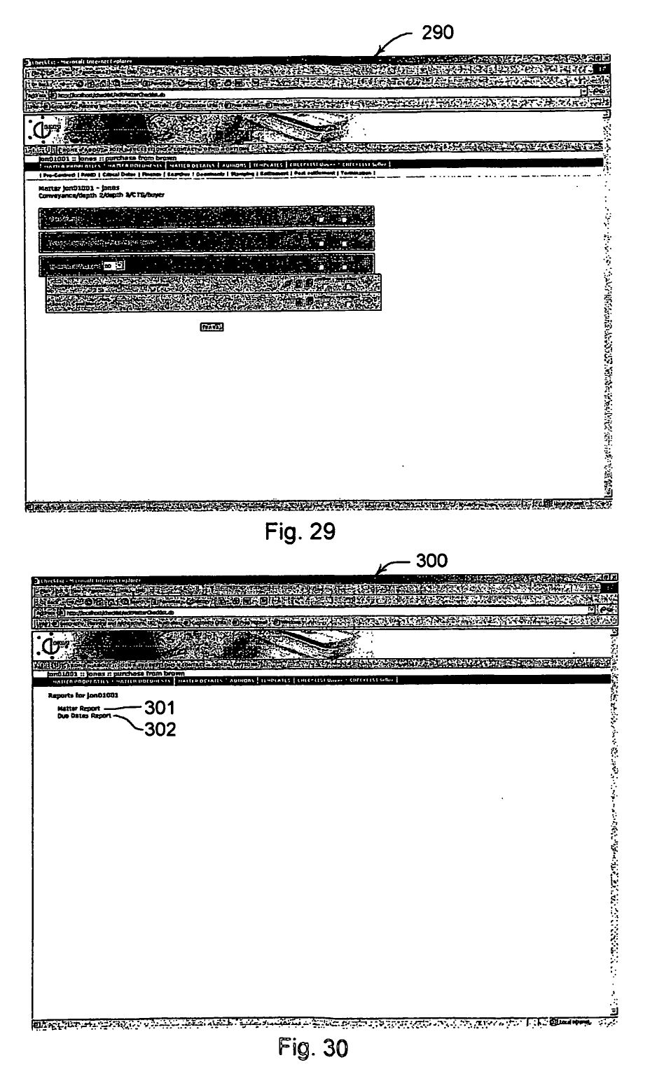

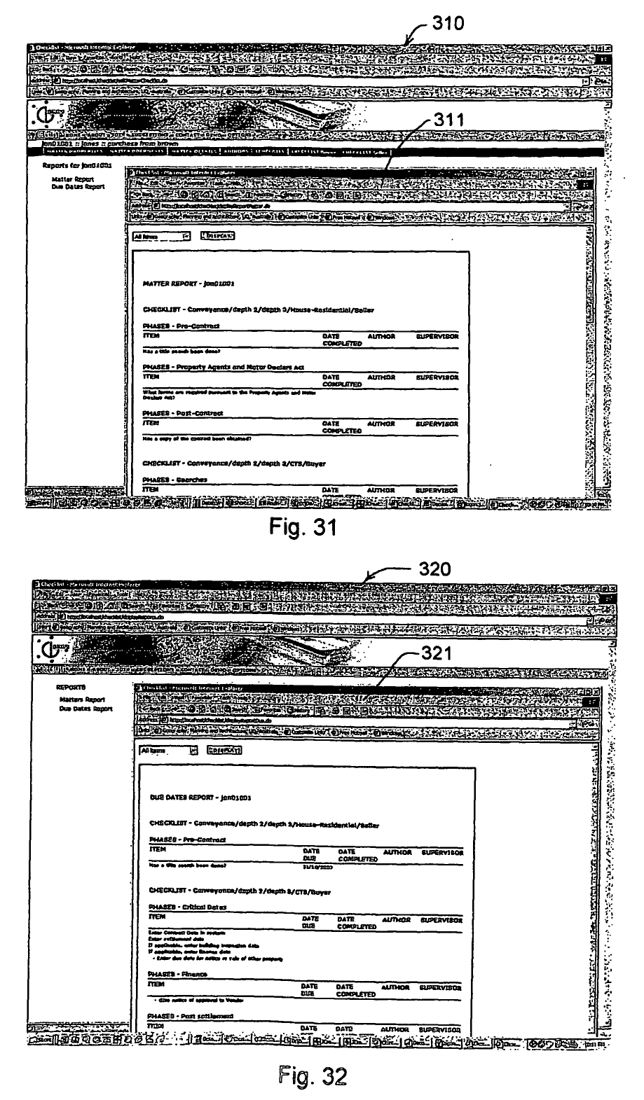

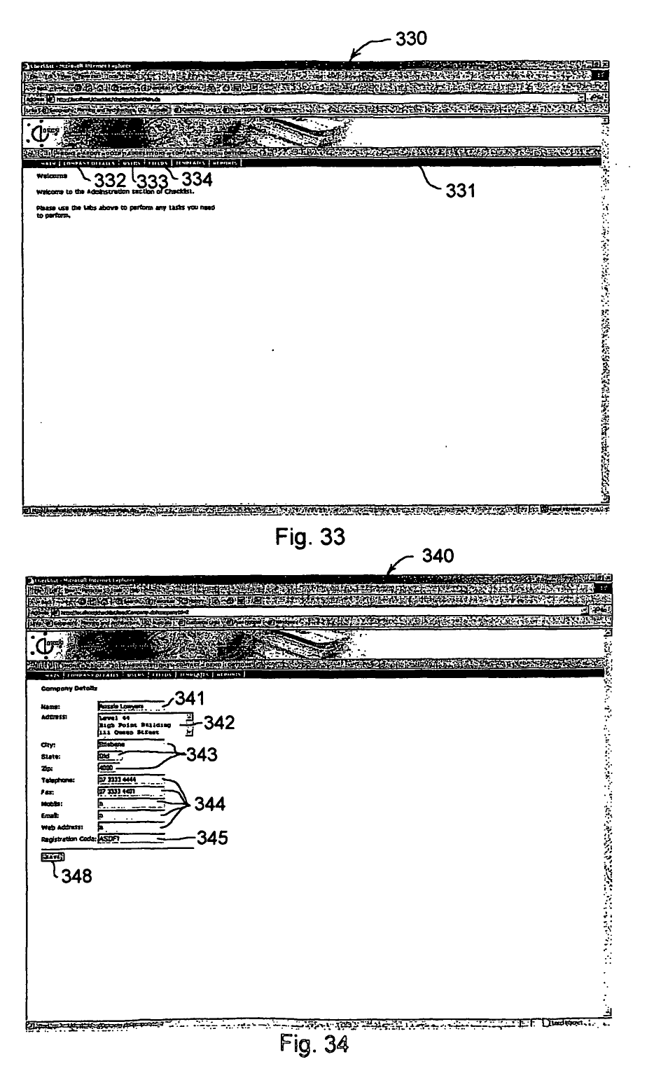

Now comparing the user screens 220 and 230 shown in FIGS. 22 and 23 with the user selection screen 100 of FIG. 10, it can be seen that by selecting “Richard Cold” from the available users in FIG. 22 and entering his name into the current author's text box, and then selecting “Jason Venerable as the supervisor, the relevant data is shown in the current author text box, the supervisor being shown at the appropriate location 231 on the screen. Now comparing the checklist selection screens 240 and 250 shown in FIGS. 24 and 25, in the version if FIG. 24, the checklist selection screen has all of its field either blank or with a “null selection” requiring the user to “select a topic” or “select a template”. Pressing the down button in any one of the topic will present a list of topics for selection by the user and depressing the download button on the template downlist will present the user with a list of selections for the template. Accordingly, as shown in FIG. 25, the first topic selected is for “conveyance”, the second topic for “depth 2”, the third topic for “depth 3”, the fourth topic for “house-residential”, and the template selected is for a “seller”. Accordingly, in the chosen template text area 125, the user is shown what topics and templates have been selected which reflect those from the downlists 121 and 122. In the checklist screen 260 shown in FIG. 26, a balloon list 261 is presented to the user when a mouse pointer or the like is hovered over the plus sign “+”, previously referred to as the action details list. The sign allows a user to either edit the properties of the action, delete the action, add an item before or after the action or add a sub-item. This very important aspect of the invention advantageously provides the user with the opportunity to modify an action list of actions to include new actions as they emerge or come to mind during practice or with a change in practice or delete them as the case may be or to change the action if a practice is amended or if it is discovered that a better quality service can be provided by making the addition, deletion or amendment. Upon the selection of this option, an execution of a modification to an action list, the user also has the opportunity to determine whether to modified checklist is saved as a precedent, or merely saved to the particular matter because the additional action of modification or modification or deletion of the action is specific to that particular matter only. Accordingly, if a new action is to be added, the action generation screen 270 shown in FIG. 27 is presented to the user having an action description text area 271 and a list of checkboxes to allow different elements as previously described to be added to the action as required. The user can determine whether the action is a query by selecting the appropriate radio button at 273. After the appropriate information has been entered, the user can determine whether the template is to be modified or not with the modify template radio buttons at 274. When satisfied that the appropriate entries have been made, the user can save the item or action to the template by pressing the save button at 275, or abort the process by pressing the back button 276. Accordingly, in the checklist screen 280 shown in FIG. 28, the new sub-item “test” has been added from the information provided in the action generation screen of FIG. 27, the sub-action being shown at 281. A further example of a checklist screen showing five actions, two of them being sub-actions, is shown in FIG. 29. The report selection screen 300 shown in FIG. 30 is presented to the user when executing the link “reports” shown at 23 in FIG. 2. The two kinds of reports listed are a matter report 301 and a due dates report 302 which are hyperlinks to further report selection screens 310 and 320 shown in FIGS. 31 and 32. In each case, the report is presented as a matter report window 311 and a due dates report window 321. These reports allow an author or supervisor to check on progress through a task having an action list of actions to be performed in performing the task. The administration section welcome window 330 shown in FIG. 33 is presented to the user upon linking thereto from the “perform administrative tasks” link 24 shown in FIG. 2. An admin jump bar 331 is provided to allow a user to perform any of the particular administrative tasks listed along the jump bar. Accordingly, the company details screen shown in FIG. 34 is presented to the user upon linking from the company details link 332 in the admin jump bar. The company details screen includes a name text box 341, an address text area 342, three address text boxes 343 for the city, state and zip or post code respectively, and five communications text boxes 344 for telephone, facsimile, mobile, email and web address. A registration code text box 345 is also provided and once the data has been appropriately entered where necessary, the save button 346 button can be pressed in the normal manner.

The user selection screen 350 is presented to the user upon execution of a user link 333 shown in FIG. 33, the user selection screen having a user list 351 listing the user by last name, first name, access and whether they are active or not and thereunder an add user button 352. When the add user button is pressed or executed, the user data entry screen 360 shown in FIG. 36 is presented to the user a series of data text boxes shown typically at 361 and a text area 362 are provided so that the information relating to name, user name, password etc can be entered as listed on the screen. The activity of the user is determined by selection of the appropriate user activity radio button 363 and whether the user is an administrator or not is selected by the appropriate radio button at 364. The data is saved once entered by pressing a save button 365 or the process can be aborted by pressing a back button 366. If the user executes a field link 334 as shown in FIG. 33, a screen is presented to the user to allow different fields to be added or removed from a particular checklist. An add property button 371 is provided which when pressed or executed allows the checklist properties screen to be modified as shown in FIG. 38 to allow the user to provide field details for an additional field to be added to the checklist. A field name, field type, whether it is active or not are all provided at 381, 382 and 383 respectively by a text box, downlist and radio buttons.

If a new document button 213 is depressed from FIG. 21, or the new document button 92 over FIG. 9, then the new document screen 390 is presented to the user which as a new document window 391 overlaid on the new document list screen similar to that of FIG. 9. In order to load a document, a file name is entered, the user being given the opportunity to browse by pressing the browse button 392, and the document is given a name in the name text box 393 and a description text area 394. The data can be saved by pressing the save button 395 and the window closed before or after saving by pressing the close button 396. The screen 400 shown in FIG. 40 indicates a method by which the software of the present invention can be integrated with popular application software such as microsoft outlook. The software and system of the invention take advantage of typical software technology normally available such as multi-media internet message extensions or multi-purpose internet mail extensions as the case may be, the windows in each case being provided with the normal window icons to shrink, expand, close and resize the window, the scroll bars, and menu items in the header. The normal peripheral functions are also provided for the normal manner making use of the services provided by the operating system software.

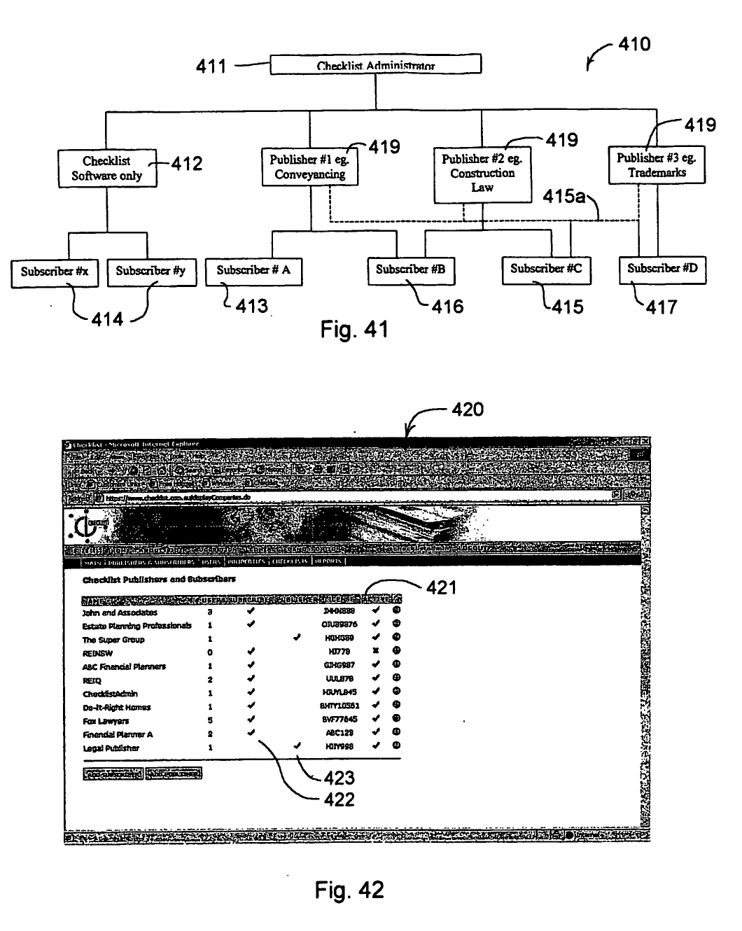

The system, software and method of the present invention may also accommodate a further layer relating to “publishers” as set out in the block diagram 410 shown in FIG. 41. Four publishers shown in the block diagram are supervised by a checklist administrator. One publisher shown at 412 only provides checklist software. Three other publishers relate to other specific areas of professional practice, such as conveyancing, construction law or trade marks law. Some subscribers may elect to subscribe to checklist software only, as shown at 414. Other subscribers may subscribe to a different selections of publishers. For example, Subscriber #A shown at 412 may subscribe only to conveyancing, whereas Subscriber #B shown at 416 may have elected to subscribe to construction law as well as to conveyancing. Subscriber #C shown at 415 in the example shown may subscribe partially to all three publishers as indicated by the dotted line at 415a, but fully to construction law. Subscriber #D is shown at 417 subscribing only to trade marks.

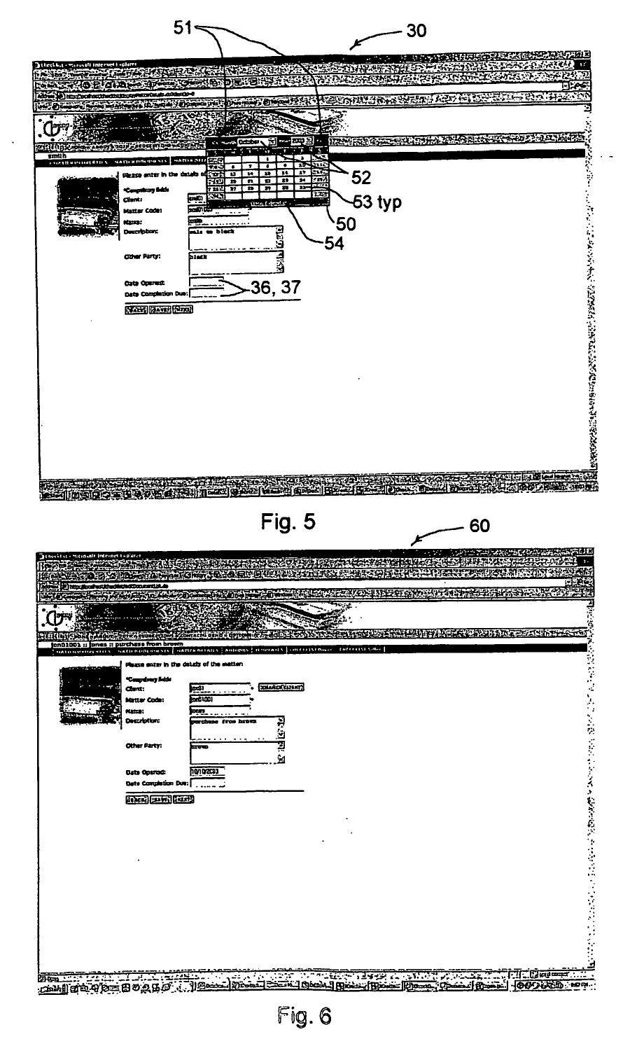

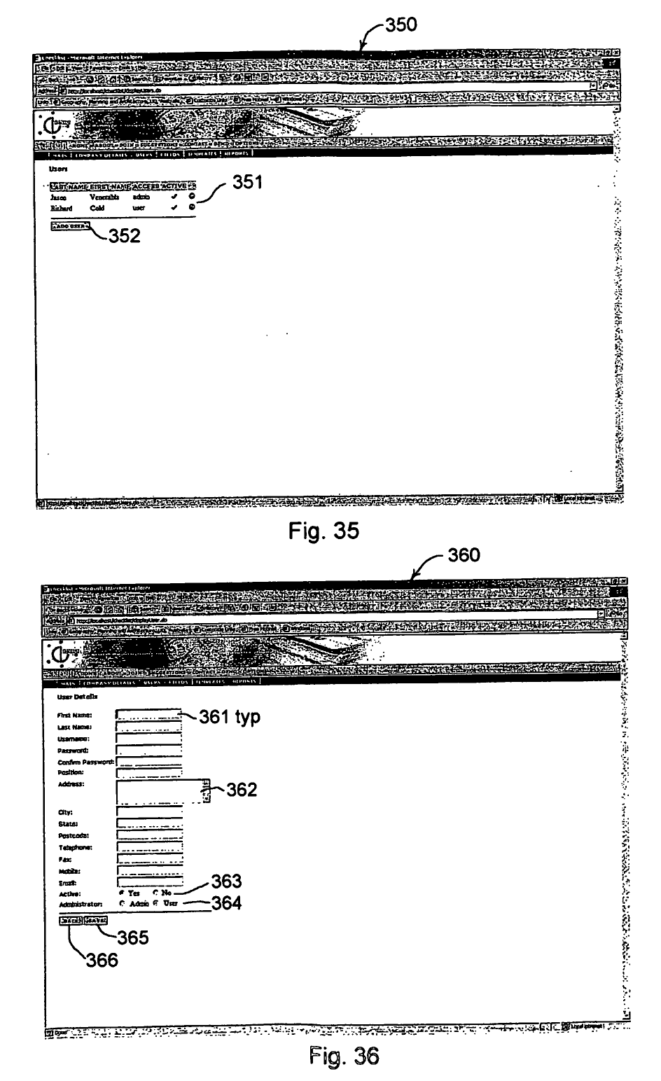

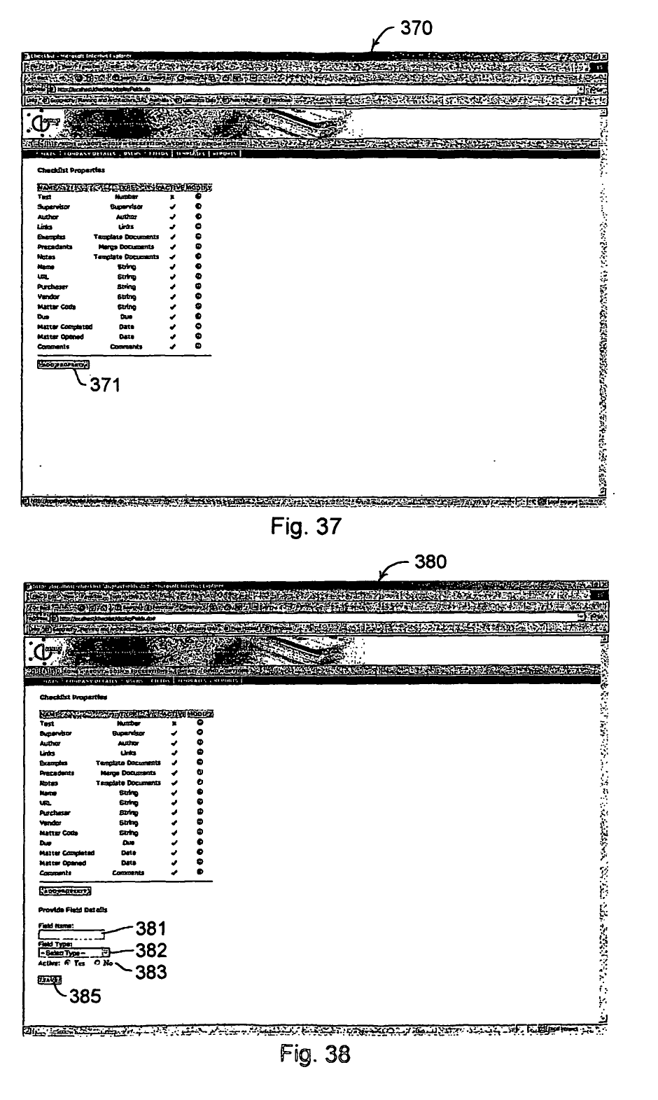

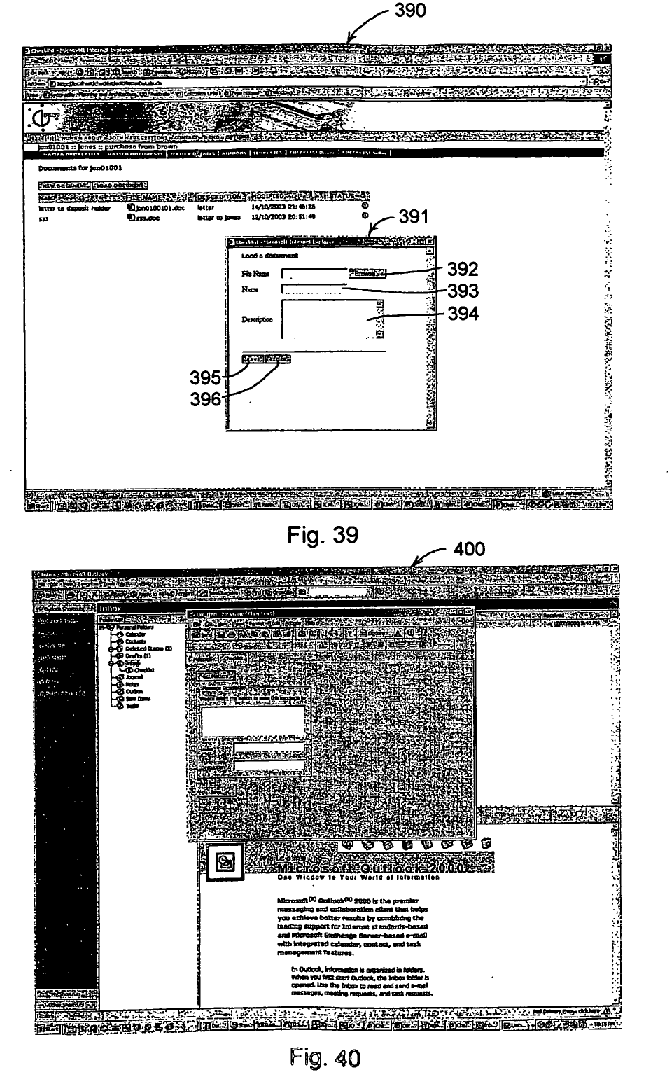

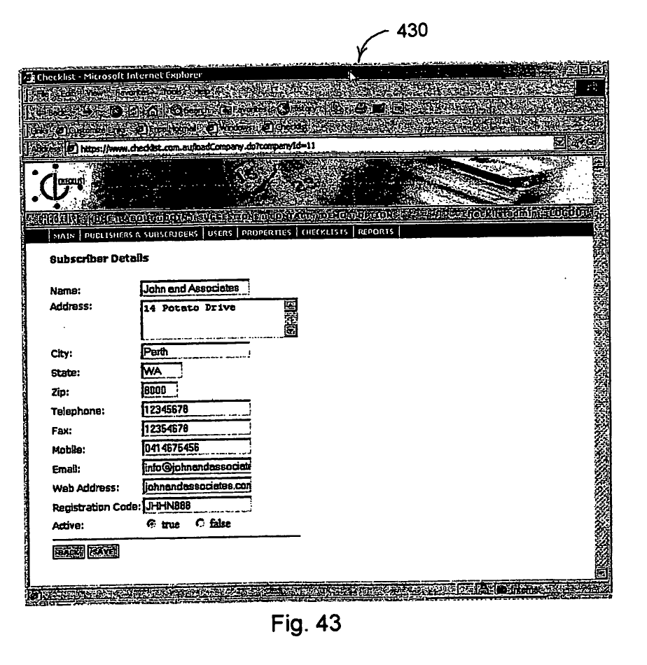

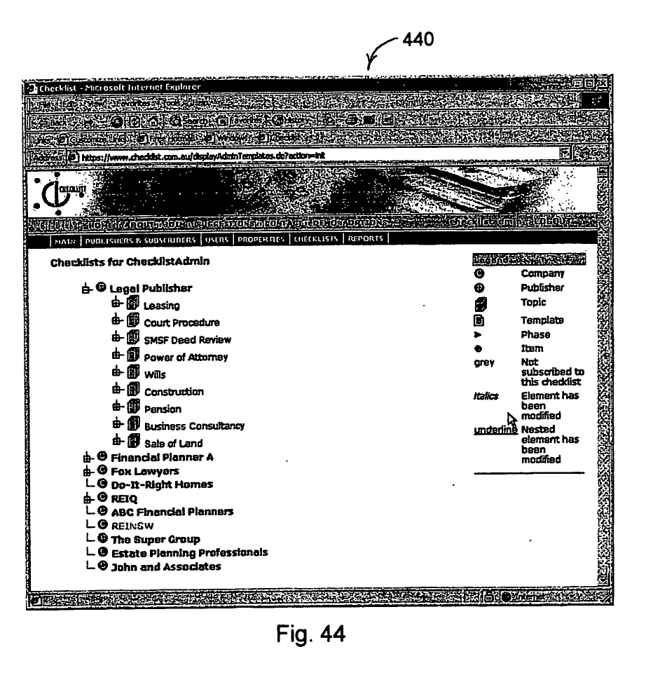

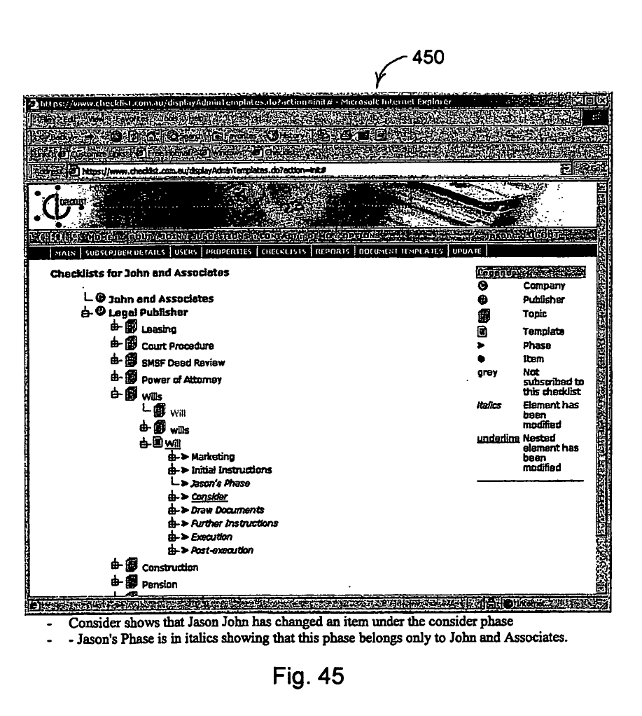

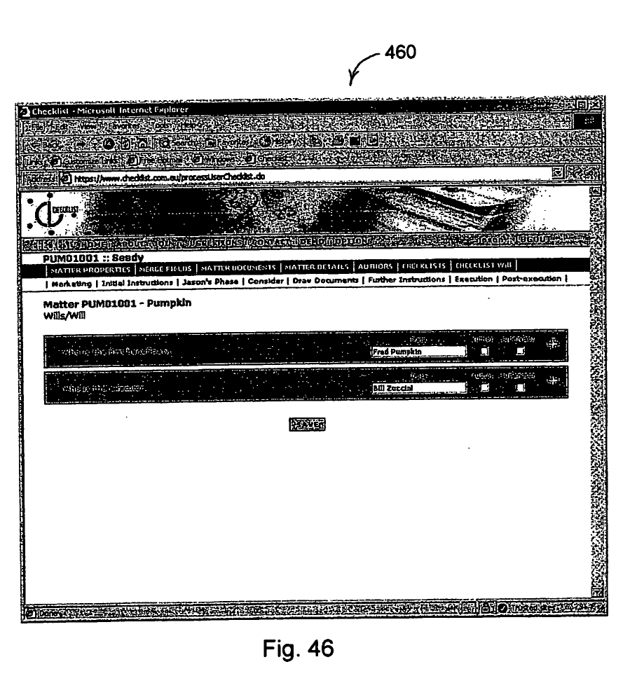

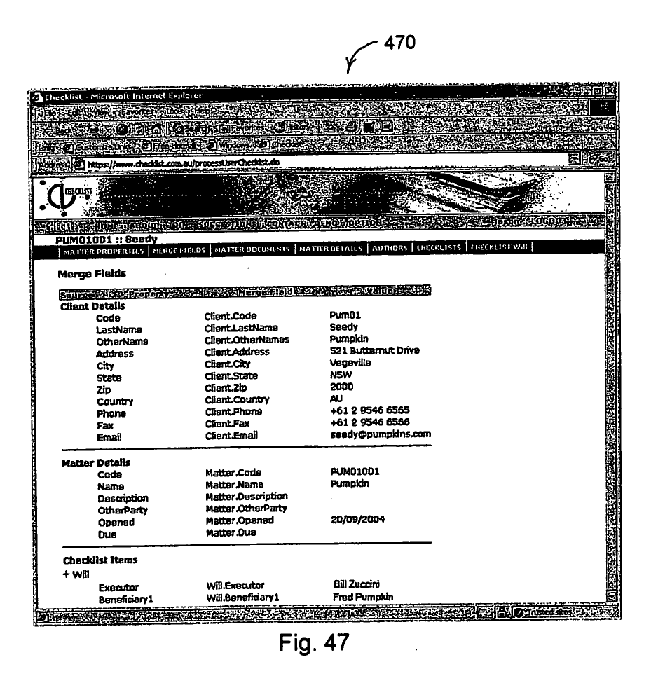

In the screen 420 chown in FIG. 42, the checklist of subscribers and publishers 421 includes an indication as to which users are subscribers in one column shown at 422, and which users are publishers in another column shown at 423. Subscriber details are shown in the text boxes set out in the screen 430 shown in FIG. 43. The checklists shown in the screens 440, 450 and 460 of FIGS. 44, 45 and 46 respectively set out details in similar fashion to the checklists hereinbefore described in respect of the other examples of the invention shown in FIGS. 1 to 40. Although the merge fields shown in the screen 470 of FIG. 47 is in respect of the subscriber and publisher structure described in respect of FIG. 41, it will be appreciated that similar arrangements may provided for the other examples of the invention shown in FIGS. 1 to 40 as well as generally in this specification.

In use, the method, software and system of the present invention may follow the following example of user session:

In step one, a user logs in with a user name and password. Once access has been granted, the user may then enter client and matter details and the like. For a new client and/or matter, the information relevant thereto is stored as new database records, but for existing clients and/or matters, a previously created record is accessed. Selection of a matter will automatically select which clients have that kind of matter (or action list), and selection of a client will provide the user with a list of matters which are accessible for that client. Incomplete activities can generate a “to do” list on a regular basis. If a new matter is to be initiated, then the user enters the action list selection area of the system and software. A series of selections is presented to the user. For example, for a property purchase, the user can first select “property purchase”, whereupon a further list of selections is provided, including, for example, “residential”, “commercial”, “collective” and the like. If the user selects “residential”, then the user can be presented with the further selections, such as, for example, “buyer”, “vendor”, “bank” and the like. If the user selects “buyer”, a action list will be opened wherein the user is acting for a client who is buying a non-commercial residential property.

The system can be used to collate questions and answers raised by usage of the method, software and system of the invention to build up a knowledge base system. The present invention provides an advantage over prior art systems in that the addition of new material is done in the action list rather than requiring updating of a database library or the like, allowing more steps to be added in the completion of a task as and when required. It is preferred that such an arrangement be server based with the user operating a client computer to access the server computer or computers in order access the action list concerned, although it may be transparent to the user as to which computer is processing the information, uploading and/or downloading information as required in doing each action to complete the task at hand.

In a preferred form, each task is provided with a master action list, and users may alter the content of the action list to provide for more complete or more efficient completion of the task. It is also preferred that the user be provided with the option of editing the master action list. In such form, it is preferred that the method of the invention include displaying the action list, providing an option to modify the data input means relevant to each actions; modifying one or more actions; and providing an option to save the modification or modifications to the displayed action list as a new action list or as a modified version of the master action list. In a further preferred form, it is preferred that the action lists be arranged in to different kinds including, for example, action lists which are client based, action lists which are article based and the master action lists as hereinbefore described.

It can be seen that the method, system and software of the present invention enables the user to be presented with a series of questions or statements requiring an answer to be entered in a field. The answer brings up a result which might be information, another question, statement or the like. The answer to the question or statement generates some sort of result that takes the user to another step. The objective of the system is to tell the operator what tasks have to be done. It can be seen that one of the advantages of the invention is that the user only accesses information which is relevant to the particular question or statement. The user does not need to sort through a large quantity of information to get the correct information for the particular task at hand. The information relevant to the task or action has already been loaded or linked through the system and software of the invention.

It can be seen that the invention allows documents to be organised according to the tasks to which they relate within a matter, rather than simply by date order or the like. This is because the links to the relevant documents are organised in a relational database, and the action list is produced as a kind of report from the database in which records relating to documents, merge fields for names, addresses and matter details and the like, are set forth in a report generated by the system engine. Moreover, when the invention is installed and run on a distributed network in which a server system is provided over a distributed network, such as the Internet, different users, or users in companies or firms together, can subscribe to the action list and have an ability to associate their own tasks etc which will be stored on the server, but accessible only by them. When the master document is modified by a master manager, those modifications will flow through to all firms, but firms will still be able to have their own additions as well which are not accessible by other firms.

A user may select from a selection of precedents one or more form letters, or compose such form letters, application forms, memoranda or such like (collectively referred to as “forms”) from a precedent bin. Some of the fields in such forms may be populated from data already input during the doing of actions or execution of operations earlier in the task, or from data specific to the form to be supplied by the user in completing the form.

It can be seen that the method, system and apparatus of the present invention provides access to specific information selected from possibly very large quantities of information. This can be accommodated by way of a master manager, but more effectively, one aspect of the present invention can be seen to accommodate the concept of a publisher. The software of the present invention can work as a database administered by a checklist administrator. Checklist, in the form of schedules of tasks, with precedent documents, notes, et cetera, can be provided by a number of publishers. A subscriber, for example, a law firm, can subscribe to the system (that is, an empty software shell) which the subscriber then completes or alternatively a subscriber can subscribe to checklists provided by one or more publishers.

It can be seen that the benefits of such an arrangement include that it allows the subscriber to use the system, it means that a publisher is able to provide knowledge, information and/or systems to users in a useable manner and in a manner whish is consistent with the user's system, a subscriber can select the publisher which they believe is the most effective in a given field rather than being required to subscribe to all of the checklists provide by one publisher. Subscribers can also customise a checklist provided by a publisher and use it to update a master checklist, enabling the subscriber to also obtain at least some of the advantages of being a publisher.

The subscriber and publisher checklists may be combined to form single checklist. For example, if a publisher provides a conveyancing checklist to, say, subscriber A, and that checklist comprises items A; B and C, and then the subscriber A wants to add Item D, then at that point, subscriber A's conveyancing checklist comprises A, B, C and D. If following that the publisher adds item A1, the subscriber's checklist is updated ti comprise A, A1, B, C and D.

Although the invention has been described with reference to one or more specific examples, it will be appreciated by persons skilled in the art that the invention may be embodied in other forms within the broad scope and ambit of the invention as defined by the following claims.

1. A method of establishing a computerised system for performing a task, including:
creating a list of actions (“action list”) to be done by a practitioner in performing a task for storage on a computer;
creating a database of information relevant to the actions on the action list for storage on the computer;
providing means for associating the actions in the action list with the relevant information in the database;
providing file opening means for opening a file for the task to be performed;
providing means for creating a file action list in the file to be opened for the task to be performed corresponding to the action list; and
providing data input means for inputting data relevant to the actions to be done on the file action list.

2. A computerised method of performing a task, including:
selecting a list of actions to be done by a practitioner in performing a task from a plurality of lists of actions, each list of actions being associated with information in a database of information relevant to the actions on that list;
opening a file for the task to be performed and creating a file action list in the file corresponding to the selected action list; and
inputting data in the file relevant to the actions to be done on the file action list.

3. A method of establishing a computerised system for performing a plurality of tasks, including;
creating a plurality of lists of actions (“action lists”) for storage on a computer, each action list including actions to be done in performing one or more of the tasks in the plurality of tasks;
creating a database of information relevant to the actions on the action lists for storage on the computer;
providing means for associating the actions in the action lists with the relevant information in the database; and
providing means for associating an action list with a task to be performed.
Preferably, the method also includes the following:
providing file opening means for opening a file for is a task to be performed selected from the plurality of tasks;
providing means for creating a file action list in the file to be opened for the task to be performed corresponding to the action list for the selected task; and
providing data input means for inputting data relevant to the actions to be done on the file action list.

4. A computerised method of performing a task, including:
selecting a task to be performed from a plurality of tasks each task being associated with a list of actions to be done in performing that task (“action list”), each list of actions being associated with information in a database of information relevant to the actions on that list;
opening a file for the task to be performed and creating a file action list in the file corresponding to the action list for the selected task; and
inputting data in the file relevant to the actions to be done on the file action list.
Preferably, the method includes providing means for storing the data for retrieval whereby the actions which have been done can be viewed.

5. A method of establishing a computerised system for performing a plurality of tasks, including;
creating a list of tasks to be performed;
creating a plurality of lists of actions (“action lists”) for storage on a computer, each action list including actions to be done by a practitioner in performing a task;
creating a database of information relevant to each action to be done for storage on the computer;
associating each action in the plurality of action lists with information in the database relevant to doing that action; and
providing means for accessing information in the database relating to an action to be taken.

6. A method of establishing a computerised system for performing a plurality of tasks, including;
creating a list of tasks to be performed;
creating a plurality of lists of actions (“action lists”) for storage on a computer, each action list including actions to be done by a practitioner in performing each of the tasks in the list of tasks;
creating a database of information relevant to the actions in the action lists;
associating each action in the plurality of action lists with information in the database relevant to doing that action; and
providing modification means for modifying the lists of tasks, lists of actions and/or the information in the database.

7. A computerised method of performing a task including:
displaying a checklist of actions to be done by the user to complete the task;
selecting one or more of the actions to be done to complete at least in part the task;
identifying one or more operations to be executed by reference to the action or to one or more other criteria;
entering data relevant to at least some actions and/or operations relevant to the doing or execution thereof; and
storing the data so entered whereby the user can check the extent to which actions and/or operations have been completed or executed in performing the task.

8. The method according to any one of claims 1, 3, 5 or 6, wherein means are provided for arranging the file according to a predetermined order.

9. The method according to claim 8, wherein means are provided for arranging the file in any suitable order at the option of the practitioner.

10. The method according to any one of claims 2, 4 or 7, wherein means are provided for arranging the file according to a predetermined order.

11. The method according to claim 10, wherein means are provided for arranging the file in any suitable order at the option of the practitioner.

12. A computer-based system operable for performing a task, including:
display means for displaying actions to be done or considered by a practitioner in performing a task to be performed;
database accessing means operably associated with the displayed actions for accessing information in a database relevant to the actions displayed;
data input means operably associated with the displayed actions for entering data obtained by reference to the information in the database;
data storage means for storing data entered via the data input means; and
data retrieval means for retrieval of the data entered whereby actions which have been done and/or considered can be viewed.

13. A system according to claim 12, wherein a front-end interface is provided operable for interactive input by a user, the front-end interface providing a plurality of menu or command based entry points to a selection of practice modules each of which relates to a task.

14. A system according to claim 13, wherein the front-end interface provides for user identity input so that a plurality of users may use the system and/or method, and a plurality of action lists is provided for the user to select a task to be performed from a plurality of different tasks.

15. A system according to claim 13 or claim 14, wherein the front-end interface includes a log-in module operable to provide individual users with a log-in identity, suitably including a log-in password.

16. A system according to any one of claims 13 to 15, wherein the front-end interface operatively interacts with a practice management engine operable to call the front-end interface and professional practice modules.

17. A computer-based system for performing a task including:
a list of actions (“action list”) to be done by a user to perform a task to be performed, the action list being displayable on a computer screen;
data input means operatively associated with each action in the action list for input of data relevant to the action;
data storage means for storing data entered via the data input means for display with the action list whereby a user may check which actions have been done in performing the task.

18. A computer program for assisting a practitioner in performing a task, including:
means for displaying actions to be done or considered by a practitioner in performing a task to be performed;
means for accessing information in a database relevant to the actions displayed;
means for entering data obtained by reference to the information in the database;
means for storing data entered via the data input means; and
means for retrieval of the data entered whereby actions which have been done and/or considered can be viewed.

19. Software for performing a plurality of tasks, including:
a database adapted to contain information relevant to actions to be done or considered in performing a plurality of tasks;
a file opening module operable to open a file for a task to be performed selected from the plurality of tasks;
a display module operable to display information from the database relevant to actions to be considered or done in performing the selected task;
a data input module operable to provide for the input of data relevant to the actions to be considered or done in performing the selected task; and
a data storage module for storing data in the file.

20. Software according to claim 19, wherein the data in the file is stored in the database of information.

21. A method of performing a plurality of tasks including:
running a program on one or more computers so as to integrate software processes, the processes including:
a database process operable to store and retrieve information relevant to actions to be done or considered in performing a plurality of tasks;
a file opening process operable to open a file for a task to be performed selected from the plurality of tasks;
a display process operable to display information from the database relevant to actions to be considered or done in performing the selected task;
a data input process operable to provide for the input of data relevant to the actions to be considered or done in performing the selected task; and
a data storage process for storing data in the file.

22. A method according to claim 21, wherein the data storage process integrates the data in the file into the database of information.

23. A method according to claim 21 or 22, wherein the processes further include a front-end interface operable for interactive input by a user, the front-end interface providing a plurality of menu or command based entry points.

24. A method according to any one of claims 21 to 23, wherein that the processes include a plurality of practitioner processes selectable from said entry points, each practice process relating to an action to be done in completing the task.

25. A method of modifying a master list of actions to be done by a practitioner in performing a task, the master list being accessible by one or more users in a network of computers, including:
providing a database of information relevant to the actions on the master list stored on one or more of the computers in the network, the information being relevant information in the database;
opening a file for the task to be performed and establishing a file action list corresponding to the master list in the file;
adding a modification to the file action list to create a modified action list; and
saving the modification to the master action list.

26. A method according to claim 25, and including the further steps of selecting a choice from a group containing the options of whether to make the modification to the file action list and the master action list or only the file action list.

27. A computer based system for performing a task, including:
a database of information including a master list of actions to be done or considered by a practitioner in performing a task to be performed;
file opening means for opening a file for the task to be performed and establishing a file action list corresponding to the master list in the file;
data input means for inputting data for adding a modification to the file action list to create a modified action list; and
data storage means for storing the modification in the master action list.

28. The system according to claim 27, and including selection means for selecting whether to store the modification in the master action list or only the file action list.

29. A computerised method of performing a task including:
having an expert in a field prepare a list of actions (“action list”) to be done in performing a task in that field;
having the expert provide relevant information associated with the actions on that list;
entering the list of actions and the information into a database; and
providing software operable to associate the information in the database with the actions to be done in performing the task.

30. A method of arranging information on a computer system relating to tasks to be performed by a practitioner, the method including:
providing a database including information required for performing a plurality of tasks;
creating an action list of actions to be done in performing each of the tasks to be performed;
operatively associating the information in the database with the actions to be done in performing each of the plurality of tasks.

31. The method according to any one of claims 1 to 11, 21 to 26, 29 or 30 and including provision for tasks to be individualised and/or categorised.

32. The software according to claim 19 or claim 20, and including provision for tasks to be individualised and/or categorised.

33. The system according to any one of claims 12 to 18, 27 or 28 and including provision for tasks to be individualised and/or categorised.

34. A method according to claim 31, software according to claim 32 or a system according to claim 33, wherein the characterisation is customer based, and the individualisation is matter based, whereby a plurality of tasks may be performed for a customer of the user, and individual tasks may be equated with a matter.

35. Software according to claim 32 or claim 34, wherein the processes are operable over a network of computers using distributed processing amongst one or more server computers and one or more client computers operatively attached in a configuration suitable for the particular network about which the invention is installed.

36. Software according to any one of claims 32, 34 or 35, wherein the software is operatively associated with normal server side services to accommodate the execution of the method according to claim 31 as a relational database having data tables relevant to customer information, user information, matter information and information relating to the action lists.

37. A method according to claim 31 or claim 34, software according to claim 32 or claim 34 or a system according to claim 33 or claim 34, wherein the tasks are categorised into a range of kinds dependent on their intended usage.

38. The method, software or system according to claim 37, wherein the kinds include client-based action lists usable on client computers, article-based action lists for carrying out a task, and master action lists to which additional actions may be added by classes of users.

39. The method, software and system according to claim 38, and including provision for users to make suggestions for changes to be made to the master action list.

40. A method of establishing a computerised system for performing a task, including:
creating a list of actions (“action list”) to be done by a practitioner in performing a task for storage on a computer;
creating an action database including information relevant to the actions on the action list for storage on the computer;
creating a subscribers database including information relevant to subscribers having access to the computerised system;
creating an information database including information (“professional information”) relevant to a field of practice of the practitioner;
creating a publisher database including information relevant to publishers of professional information;
providing means for associating the actions in the action list with the relevant information in the database;
providing file opening means for opening a file for the task to be performed;
providing means for creating a file action list in the file to be opened for the task to be performed corresponding to the action list;
providing database access means for subscribers to subscribe to information contained in any one or more of the databases; and
providing data input means for inputting data relevant to the actions to be done on the file action list.
